(19) United States
(12) Patent Application Publication
(10) Pub. No.: US 2026/0227940 A1
(43) Pub. Date: Aug. 6, 2026

(54) PRINTING APPARATUS AND NON-TRANSITORY MEDIUM STORING PROGRAM FOR PRINTING APPARATUS

(71) Applicant: BROTHER KOGYO KABUSHIKI KAISHA, Nagoya (JP)

(72) Inventors: Yoshitsugu TOMOMATSU, Nagoya (JP); Tomoyasu FUKUI, Inuyama (JP); Yuichiro SUZUKI, Komaki (JP); Yosuke OHASHI, Nisshin (JP); Keisuke NISHIHARA, Nagoya (JP)

(21) Appl. No.: 19/461,428

(22) Filed: Jan. 27, 2026

(30) Foreign Application Priority Data
Jan. 31, 2025 (JP) 2025-015406

(51) Int. Cl. G06F 3/12

(52) U.S. Cl. CPC G06F 3/1257; G06F 3/1204; G06F 3/1226; G06F 3/1243; G06F 3/1294

(57) ABSTRACT

A printing apparatus includes: a first memory, a printing mechanism, a communication interface, and a processor. The first memory stores a template database including one or more records each including a template ID and template data. In a case where the processor obtains a print instruction including the template ID and related information related to print content data, the processor causes the printing mechanism to perform printing of a print image in which a print content is applied to a layout indicated by the template data associated with the template ID. In a case where the printing of the print image is not completed and where another printing apparatus is connected to the printing apparatus, the processor queries, to the another printing apparatus, whether the another printing apparatus possesses the template data associated with the template ID.

### REFERENCE TO RELATED APPLICATIONS

This application claims priority from Japanese Patent Application No. 2025-015406 filed on January 31, 2025. The entire content of the priority application is incorporated herein by reference.

### BACKGROUND ART

A known label printer receives a print instruction including additional image information on an additional image, and template identifying information from an external apparatus. In a case where a background image associated with the template identifying information is stored in a background image memory, the label printer performs a printing process of printing, on a label, a label image obtained by synthesizing the additional image and the background image. On the other hand, in a case where the background image associated with the template identifying information is not stored in the background image memory, the label printer does not perform the printing process.

### SUMMARY

In a case where an error occurs in a printing apparatus during the printing based on the print instruction, a user desires to continue the printing based on the print instruction in a substitute printing apparatus, in some cases. The substitute printing apparatus might not store a template used by the printing apparatus in which the error has occurred. In the known label printer or printing apparatus, however, an appropriate process to be performed depending on whether the template is stored or not in the substitute printing apparatus has not been proposed.

An object of the present disclosure is to provide a printing apparatus, and a non-transitory medium storing a program for the printing apparatus, each capable of performing an appropriate process in a case where another printing apparatus is used as a substitute for a printing apparatus, and depending on whether a template is stored or not in the another printing apparatus.

A printing apparatus according to a first aspect of the present disclosure includes: a first memory, a printing mechanism, a communication interface, and a processor. The first memory stores a template database including one or more records, each of the one or more records including a template ID and template data. The template data is used to print a predetermined print content based on a predetermined layout. The template ID is associated with the template data.

The processor is configured to cause the printing apparatus to perform an obtaining process, a first printing process, a first querying process, and a first transmitting process. The obtaining process is a process of obtaining a print instruction including related information related to print content data which indicates the print content, and the template ID. The first printing process is a process of causing the printing mechanism to perform printing of a print image. The print image is an image in which the print content related to the related information is applied to the layout indicated by the template data associated with the template ID. The first printing process is performed in a case where the processor obtains the print instruction in the obtaining process.

The first querying process is a process of querying another printing apparatus whether the another printing apparatus possesses the template data associated with the template ID via the communication interface. The first querying process is performed in a case where the printing by the first printing process is not completed and where the another printing apparatus is connected to the printing apparatus. The first transmitting process is a process of transmitting the print instruction to the another printing apparatus via the communication interface. The first transmitting process is performed in a case wherea result of the first querying process is that the another printing apparatus possesses the template data associated with the template ID.

The printing apparatus according to the first aspect queries the another printing apparatus whether the another printing apparatus possesses the template data to be used in the printing. In a case where the another printing apparatus possesses the template data to be used in the printing, the printing apparatus transmits the print instruction to the another printing apparatus. Thus, the printing apparatus contributes to causing the another printing apparatus to print, on a print medium, the appropriate print image based on the print instruction.

A printing apparatus according to a second aspect of the present disclosure is configured to substitute for another printing apparatus so as to perform printing in a case where printing by the another printing apparatus is not completed. The printing apparatus includes: a second memory; a communication interface, a printing mechanism, and a processor. The second memory stores a template database including one or more records, each of the one or more records including a template ID and template data. The template data is used to print a predetermined print content based on a predetermined layout. The template ID is associated with the template data.

The processor is configured to cause the printing apparatus to perform a second accepting process; a responding process; a second receiving process and a second printing process. Thesecond acceptingprocess is a process of accepting a query as to whether the printing apparatus possesses the template data associated with the template IDfrom the another printing apparatus via the communication interface. The responding process is a process of responding that the printing apparatus possesses the template data to the another printing apparatus via the communication interface. The responding process is performed in a case where the template data associated with the template ID is stored in the second memory.

The second receiving process is a process of receiving a print instruction including identification information and the template ID from the another printing apparatus via the communication interface. The identification information is used to identify the print content. The second printing process is a process of causing the printing mechanism to perform printing of a print image in which the print content based on the print instruction is applied to the layout indicated by the template data. The second printing process is performed in a case where the processor receives the print instruction in the second receiving process.

The printing apparatus according to the second aspect accepts a query as to whether the printing apparatus possesses the template data from the another printing apparatus. In a case where the printing apparatus possesses the template data, the printing apparatus receives the print instruction from the another printing apparatus. Therefore, the printing apparatus contributes to printing, on a print medium, an appropriate print image based on the print instruction, as a substitute for the another printing apparatus.

A program for a printing apparatus according to a third aspect of the present disclosure is a program to cause a processor of the printing apparatus to perform processing. The printing apparatus includes: a first memory; a printing mechanism; a communication interface; and a processor.

The first memory stores a template database including one or more records, each of the one or more records including a template ID and template data. The template data is used to print a predetermined print content based on a predetermined layout. The template ID is associated with the template data.

The program for the printing apparatus causes the processor of the printing apparatus to perform: an obtaining process, a first querying process, and a first transmitting process. The obtaining process is a process of obtaining a print instruction including related information related to print content data, which indicates the print content, and the template ID. The first printing process is a process of causing the printing mechanism to perform printing of a print image. The print image is an image in which the print content related to the related information, is applied to the layout indicated by the template data associated with the template ID. The first printing process is performed in a case where the processor obtains the print instruction in the obtaining process.

The first querying process is a process of querying another printing apparatus whether the another printing apparatus possesses the template data associated with the template ID via the communication interface. The first querying process is performed in a case where the printing by the first printing process is not completed and where the another printing apparatus is connected to the printing apparatus. The first transmitting process is a process of transmitting the print instruction to the another printing apparatus via the communication interface. The first transmitting process is performed in a case wherea result of the first querying process is that the another printing apparatus possesses the template data associated with the template ID. Therefore, the third aspect achieves the effect similar to the effect achieved by the first aspect.

The present disclosure may optionally combine any of the specific features as defined in claims 1 to 22.

### BRIEF DESCRIPTION OF DRAWINGS

FIG. 1 is a diagram illustrating the configuration of a print substitution system.

FIG. 2A is a diagram schematically illustrating a predefined text DB and FIG. 2B is a diagram schematically illustrating a template DB.

FIGS. 3A to 3C are diagrams schematically illustrating cases where substitute printing are performed by the print substitution system.

FIG. 4 is a sequence diagram (1/9) of a process performed by the print substitution system.

FIG. 5 is a sequence diagram (2/9) of the process performed by the print substitution system.

FIG. 6 is a sequence diagram (3/9) of the process performed by the print substitution system.

FIGS. 7A and 7B are a sequence diagram (4/9) of the process performed by the print substitution system.

FIG. 8 is a sequence diagram (5/9) of the process performed by the print substitution system.

FIG. 9 is a sequence diagram (6/9) of the process performed by the print substitution system.

FIGS. 10A and 10B are a sequence diagram (7/9) of the process performed by the print substitution system.

FIGS. 11A and 11B are a sequence diagram (8/9) of the process performed by the print substitution system.

FIG. 12 is a sequence diagram (9/9) of the process performed by the print substitution system.

### DESCRIPTION

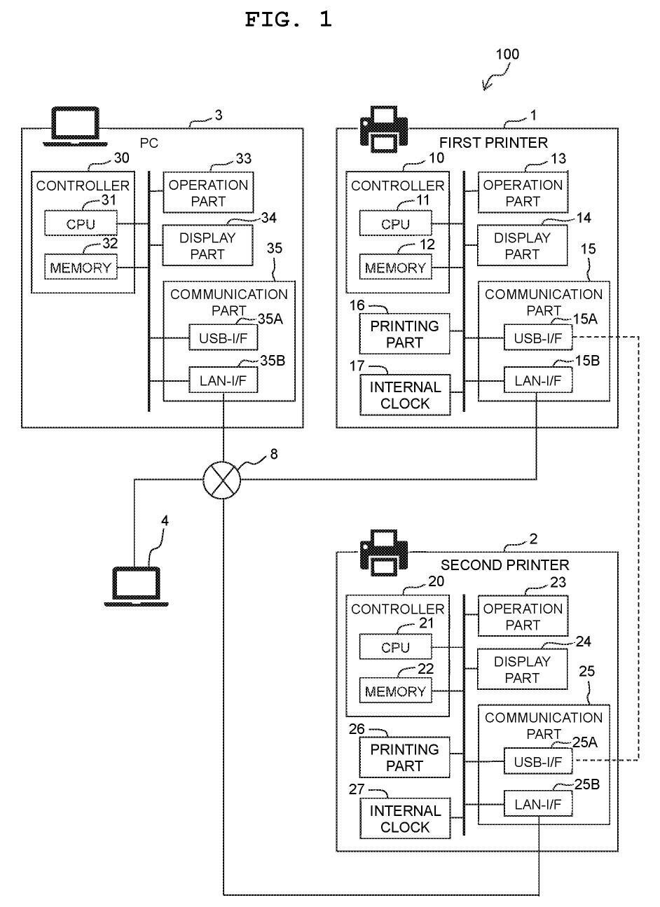

Anembodiment of the present disclosure will be described, with reference to the drawings. The configuration of a print substitution system 100 will be described, with reference to FIG. 1. The drawings referred to are used to describe the technical features which the present disclosure may adopt. The configuration, etc., of the apparatus described herein is not intended to limit the present disclosure in any way, but is merely a descriptive example of the present disclosure.

The print substitution system 100 is a system which connects a second printer 2 to a first printer 1 in a case where the first printer 1 is in a state where printing by the first printer 1 is not completed, and uses the second printer 2 for printing. As illustrated in FIG. 1, the print substitution system 100 includes a PC 3, the first printer 1, the second printer 2, and a server 4. Note that the term "PC" is an abbreviation for "personal computer". The PC 3 is an apparatus which is, for example, operated by a user, and which outputs a print instruction to the first printer 1. The first printer 1 and the second printer 2 may be of the same model and may have the same functions. Alternatively, the first printer 1 and the second printer 2 may be of different models and may have different functions.

The PC 3 includes a controller 30, an operation part 33, a display part 34, and a communication part 35. The controller 30 includes a CPU 31 and a memory 32. The CPU 31 controls the overall operation of the PC 3.

The memory 32 is, for example, a volatile memory, a non-volatile memory, etc. The memory 32 stores at least an OS, a print application program, and various data. In the following description, the application program is also referred to simply as an "application". The OS is a program which controls the basic operation of the PC 3. The print application is a program which generates the print instruction to cause the first printer 1 to perform printing.

The operation part 33 is an input device configured to input various information into the PC 3. The operation part 33 includes, for example, a mouse, a keyboard, etc. The display part 34 is a display configured to display the various information.

The communication part 35 includes a USB I/F 35A and a LAN I/F 35B. Note that the term "I/F" is an abbreviation for "interface". The USB I/F 35A is a connection interface configured to connect computer peripherals to the PC 3 via USB. The computer peripherals are various devices connected to and used with a computer. The USB I/F 35A supports the USB printer class.

The LAN-I/F 35B is a connection interface configured to connect to a network 8 and to perform communication between terminals or with the computer peripherals. The network 8 may be a LAN, the Internet, or a dedicated line, or may be a configuration including two or more of the LAN, the Internet, and the dedicated line. The PC 3 may be directly connected to and may communicate with the computer peripherals using the LAN-I/F 35B.

The first printer 1 is a computer peripheral having a print function. The first printer 1 according to the embodiment is a label printer which performs printing on labels. The first printer 1 may also be a roll printer which performs printing on a roll sheet, or a page printer which performs printing on cut sheets. Further, the first printer 1 may be a multifunction peripheral having, for example, a scan function, a FAX function, etc., in addition to the print function.

The first printer 1 includes a controller 10, an operation part 13, a display part 14, a communication part 15, a printing part 16, and an internal clock 17. The controller 10 includes a CPU 11 and a memory 12. The CPU 11 controls the overall operation of the first printer 1.

The memory 12 is, for example, a volatile memory, a non-volatile memory, etc. The memory 12 stores at least a control application, a substitute application, a predefined text DB, and a template DB. Note that the term "DB" is an abbreviation for "database". The control application is a program for controlling the basic operation of the first printer 1. The control application is executed when the first printer 1 starts up. The substitute application of the first printer 1 is a program which performs various processes to cause the second printer 2 to perform the printing, instead of the first printer 1.

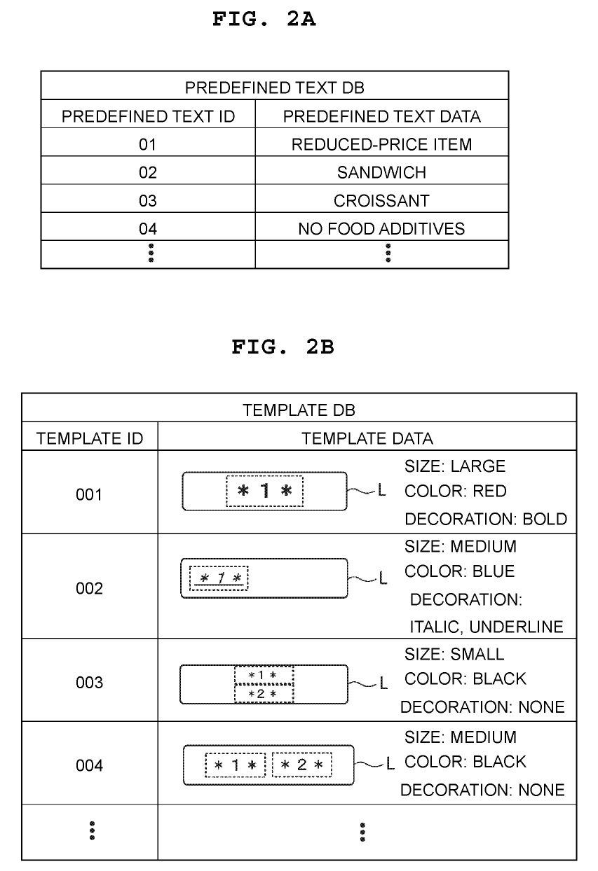

FIG. 2A illustrates an example of the predefined text DB. The predefined text DB is a database including a plurality of records. Each of the records includes predefined text data and a predefined text ID. The predefined text data indicates a predefined text generated in advance to be printed on a label, and is associated with the predefined text ID which is ID for identifying the predefined text data. In the example illustrated in FIG. 2A, the predefined texts are represented, for example, by texts such as "sandwich", "croissant", etc. For example, a predefined text indicated by predefined text data associated with a predefined text ID "01" is "reduced-price item".

FIG. 2B illustrates an example of the template DB. The template DB is a database including a plurality of records. Each of the records includes template data and a template ID. The template data is data of a template which predefines a layout to which print content is to be applied. In the embodiment, the print content is, for example, a predetermined text or input text inputted by a user. The layout is information which specifies layout position, size, decoration, etc. that are applied when printing the predetermined text or the input text on a label.

FIG. 2B illustrates, in a template data field, an example of the template data. In a print area, in a label L, of the template data, a dotted frame indicates a position in which a predefined text or an input text is disposed. In FIG. 2B, a dotted frame displayed as "*1*" indicates a position in which a first predefined text or a first input text is disposed. In a case where a plurality of predefined texts or input texts exist, e.g., two predefined texts or two input texts exist, the first predefined text or input text of the two predefined texts or input texts is disposed in the dotted frame displayed as "*1*, and the second predefined text or input text is disposed in a dotted frame displayed as "*2*". Further, with respect to each of the plurality of predefined texts or input texts, the text size is preset as large, medium, or small, and text color, text decoration, etc., are also preset. The size of the dotted frame is appropriately adjusted in accordance with, for example, the number of characters, the text size, etc.

For example, template data associated with a template ID "001" includes a layout in which one predefined text or input text is disposed in a dotted frame displayed as "*1*" in the center of the label L. For example, in a case where the predefined text ID "01" and the template ID "001" are designated, the text "reduced-price item" in red letters decorated in large-sized and bold font is printed in the center of the label L.

Template data associated with a template ID "003" includes a layout in which two predefined texts or input texts are disposed in two rows at the center of the label L. For example, in a case where predefined text IDs "02" and "04" and a template ID "003" are designated, a first predefined text is disposed in an upper dotted frame displayed as "*1*", and a second predefined text is disposed within a lower dotted frame displayed as "*2*". That is, a label L in which a text "sandwich" and a text "No food additives" in small and black font are disposed in the two rows is printed.

The operation part 13 includes a plurality of keys. By operating the operation part 13, the user is capable of inputting various instructions into the first printer 1. The display part 14 is a display configured to indicate various information.

The communication part 15 includes a USB-I/F 15A and a LAN-I/F 15B. The USB-I/F 15A is a connection interface configured to establish a USB connection with the computer equipment including the PC 3, and with the computer peripherals including the second printer 2. The USB-I/F 15A supports network connection via the Ethernet over USB protocol. The LAN-I/F 15B is a connection interface configured to connect to the network 8 and to communicate with the computer equipment including the PC 3. The USB-I/F 15A supports the USB printer class.

The printing part 16 is a printing mechanism configured to perform printing on labels. In a template print mode, the printing part 16 prints, on a label, a print image in which a template is applied to a predefined text or input text. The internal clock 17 is a clock built into the first printer 1 and is powered by a battery.

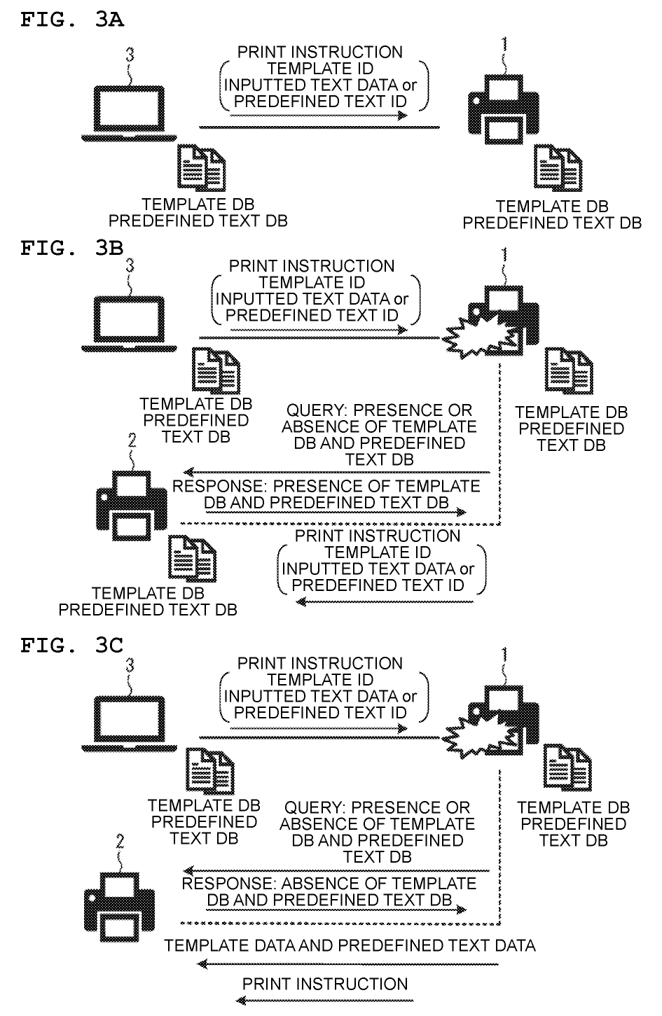

The template print mode is a print mode wherein a process of synthesizing a print image in which a template is applied to a predefined text or input text and of printing the print image on a label in the first printer 1 is performed. As illustrated in FIG. 3A, the template DB and the predefined text DB are stored in advance in the memory 32 of the PC 3 and the memory 12 of the first printer 1.

In the template print mode, the PC 3 prepares input text data, or a predefined text ID associated with a predefined text designated by the user, and a template ID corresponding to a template designated by the user. The input text data is data of the text input by the user. The PC 3 generates a print instruction including the template ID, the input text data or the predefined text ID, and information necessary for printing, and transmits the print instruction to the first printer 1. The information necessary for the printing includes, for example, print position in accordance with the label width, margin setting, magnification, the number of copies, and the other information. In the template print mode, the print instruction received by the first printer 1 may not include the template data, or image data based on the template data and print content data.

In a case where the print instruction includes the predefined text ID, the first printer 1 extracts predefined text data, associated with the predefined text ID, from the predefined text DB. The first printer 1 extracts templatedata, associated with the template ID included in the print instruction, from the template DB. The first printer 1 synthesizes a print image in which the template indicated by the template data is applied to either the input text indicated by the input text data or the predefined text indicated by the predefined text data. The print image is raster data composed of pixels. The first printer 1 prints the print image on the label based on the information necessary for printing.

Note that the first printer 1 has, for example, a normal print mode as another print mode different from the template print mode. In the normal print mode, the first printer 1 prints a print image synthesized in the PC 3 on the label. In the normal print mode, the PC 3 prints the input text input by the user, or the predefined text designated by the user, on the label using the layout set by the user, rather than using the template data stored in the memory 12 of the first printer 1. The PC 3 generates a print instruction including a print image indicating the input text or the predefined text, either in the layout designated by the user or in the layout applied based on the template data stored in the PC 3, together with the information necessary for printing the print image, and the PC 3 transmits the print instruction to the first printer 1. The first printer 1 prints the print image on the label based on the print instruction. In the normal print mode, the print instruction received by the first printer 1 may include the template data, or image data based on both the template data and the print content data.

The second printer 2 is a computer peripheral having the print function. The second printer 2 in the first embodiment is, for example, a printer of the same series as the first printer 1. The first printer 1 and the second printer 2 may be printers of the same series or of different series.

The second printer 2 includes a controller 20, an operation part 23, a display part 24, a communication part 25, a printing part 26, and an internal clock 27. The controller 20 includes a CPU 21 and a memory 22. The CPU 21 controls the overall operation of the second printer 2.

The memory 22 is, for example, a volatile memory, a non-volatile memory, etc. The memory 22 stores at least a control application and a substitute application. The control application is executed when the second printer 2 starts up. The substitute application of the second printer 2 is a program which performs various processes to cause the second printer 2 to perform printing, instead of the first printer 1.

The operation part 23 includes a plurality of keys. By operating the operation part 23, the user is capable of inputting various instructions into the second printer 2. The display part 24 is a display configured to indicate various information.

The communication part 25 includes a USB-I/F 25A and a LAN-I/F 25B. The USB-I/F 25A is a connection interface for establishing the USB connection with the computer equipment including the PC 3, and with the computer peripherals including the first printer 1. Note that the USB-I/F 25A supports network connection via the Ethernet over USB protocol. In a case wherethe second printer 2 performs the substitute printing for the first printer 1, the first printer 1 is connected to the USB-I/F 25A via USB. Similarly, in a case wherea third printer performs the substitute printing for the second printer 2, the third printer is connected to the USB-I/F 25A via USB. The LAN-I/F 25B is a connection interface configured to connect to the network 8 and to communicate with the computer equipment including the PC 3. Note that the USB-I/F 25A supports the USB printer class.

The printing part 26 is a printing mechanism configured to perform printing on the labels. In the template print mode, the printing part 26 synthesizes a print image in which a template is applied to a predefined text or an input text, and prints the print image on the label. The internal clock 27 is a clock built into the second printer 2 and is powered by a battery.

The server 4 is a server capable of providing the template DB and predefined text DB to the first printer 1 and the second printer 2. The user operates the first printer 1 and the second printer 2 to download the template DB and the predefined text DB from the server 4 and store the template DB and the predefined text DB in the memory 12 and the memory 22 of the first printer 1 and the second printer 2, respectively. In a case where the printing is performed on labels which do not use the template data or the predefined text data, the download of the template DB and the predefined text DB is not required. Therefore, the versions of the template DB and predefined text DB stored in first printer 1 may differ from the versions of the template DB and predefined text DB stored in second printer 2.

The first printer 1 and the second printer 2 are each connected to the PC 3 via the network 8. The PC 3 communicates with the first printer 1 or the second printer 2 via the network 8 and is capable of causing each of the first printer 1 and the second printer 2 to perform printing on the labels.

Next, a flow in a case where the printer 1 is in a state where the printing by the first printer 1 is not completed and where the second printer 2 performs the substitute printing for the first printer 1 will be schematically described. The substitute printing refers to such printing performed in a case where the printing based on the print instruction received by the first printer 1 is not completed due to, for example, an error, the second printer 2 performs the printing based on that print instruction in substitution for the first printer 1. In this case, the substitute printing is performed such that the first printer 1 transmits, to the second printer 2, the print instruction which has been transmitted to the first printer 1 by the PC 3, rather than the PC 3 newly transmits, to the second printer 2, the print instruction which the PC 3 previously has transmitted to the first printer 1. Therefore, the communication between the first printer 1 and the second printer 2 is performed via a peer-to-peer connection. In the embodiment, in a case where the first printer 1 and the second printer 2 transition to a substitution mode which will be described later, and establish the USB connection, the first printer 1 and the second printer 2 are enabled to communicate with each other via a USB cable.

As illustrated in FIG. 3A, the print application is executed in the PC 3. In the template print mode, the PC 3 generates a print instruction including the input text data or the predefined text ID, and the template ID, and transmits the print instruction to the first printer 1. Note that the PC 3 may not store the template DB or the predefined text DB.

In a case where the print instruction received from the PC 3 includes the input text data, the first printer 1 stores the input text data in the memory 12. In a case wherethe print instruction received from the PC 3 includes the predefined text ID, the first printer 1 extracts predefined text data, associated with the predefined text ID, from the predefined text DB and stores the predefined text data in the memory 12. The first printer 1 extracts template data, associated with the template ID included in the print instruction received from the PC 3, from the template DB and stores the template data in the memory 12. The first printer 1 synthesizes a print image in which the input text indicated by the input text data, or the predefined text indicated by the predefined text data, is applied to the template indicated by the template data.

The first printer 1 prints the print image on the label based on the information necessary for printing included in the print instruction.

As illustrated in FIG. 3B, in a case where the first printer 1 is in the state where the printing by the first printer 1 is not completed due to, for example, an error, etc., the user connects the second printer 2 to the first printer 1 via USB. The first printer 1 queries the second printer 2 whether the memory 22 stores the predefined text data associated with the predefined text ID and the template data associated with the template ID. In a case where the print instruction received from the PC 3 does not include the predefined text ID and includes the input text data, the first printer 1 queries the second printer 2 whether the memory 22 stores the template data. In a case where the first printer 1 receives a response from the second printer 2 that the memory 22 stores the predefined text data and the template data, the first printer 1 transmits a print instruction including the predefined text ID and the template ID to the second printer 2.

The second printer 2 stores the input text data in the memory 22, in a case where the print instruction received from the first printer 1 includes the input text data. In a case where the print instruction received from the first printer 1 includes the predefined text ID, the second printer 2 extracts predefined text data associated with the predefined text ID from the predefined text database and stores the predefined text data in the memory 22. The second printer 2 extracts template data associated with the template ID included in the print instruction from the template DB and stores the template data in the memory 22. The second printer 2 synthesizes a print image in which the input text indicated by the input text data or the predefined text indicated by the predefined text data is applied to the template indicated by the template data. The second printer 2 prints the print image on the label based on the information included in the print instruction and necessary for the printing.

As illustrated in FIG. 3C, the first printer 1 may receive a response from the second printer 2 that the memory 22 does not store the predefined text data and the template data. In this case, the first printer 1 transmits the predefined text data, the template data, and the print instruction to the second printer 2.

The second printer 2 stores input text data in the memory 22, in a case where the print instruction received from the first printer 1 includes the input text data. The second printer 2 stores the predefined text data and the template data received from the first printer 1 in the memory 22. The second printer 2 synthesizes a print image in which the input text indicated by the input text data or the predefined text indicated by the predefined text data is applied to the template indicated by the template data. The second printer 2 prints the print image on the label based on the information included in the print instruction and necessary for the printing.

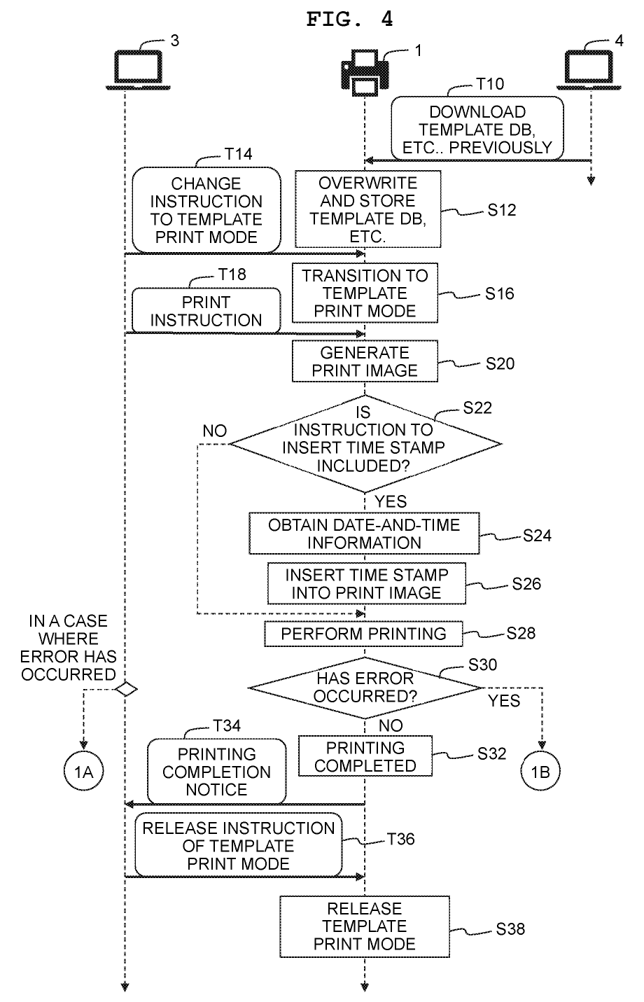

The flow of a process in which the second printer 2 performs the substitute printing for the first printer 1 in the print substitution system 100 of the embodiment is described, with reference to the sequence diagrams of FIGS. 4 to 12. Note that in the following descriptions of the sequence diagrams, a process performed by the CPU of each of the devices (the PC 3, the printer 1, the printer 2) is described with each of the devices as the subject of the process, rather than describing the CPU of each of the devices as the subject of the process, for the sake of convenience. That is, the processes performed, respectively, by the CPUs 31, 11, and 21 of the PC 3, the first printer 1, and the second printer 2, respectively, are described as the processes performed, respectively, by the PC 3, the first printer 1, and the second printer 2.

Further, in the following description of the sequence diagrams, the communication between or among the devices is executed via the communication parts of the devices, respectively. Specifically, the PC 3 and the first printer 1 communicate via the network 8 connecting the PC 3 and the first printer 1 via the LAN-I/F 35B and the LAN-I/F15B. Therefore, the communication between the PC 3 and the first printer 1 is executed via the LAN-I/F 35B and the LAN-I/F 15B. Furthermore, the PC 3 and the second printer 2 also communicate via the network 8 connecting the PC 3 and the second printer 2 via the LAN-I/F 35B and the LAN-I/F 25B. Therefore, the communication between the PC 3 and the second printer 2 is executed via the LAN-I/F 35B and the LAN-I/F 25B.

In a case where the second printer 2 performs the substitute printing for the first printer 1, the first printer 1 and the second printer 2 are connected via USB, via the USB-I/F 15A and the USB-I/F 25A. Therefore, the communication between the first printer 1 and the second printer 2 is executed via the USB-I/F 15A and the USB-I/F 25A. Thus, the PC 3, the first printer 1, and the second printer 2 communicate via the connection interfaces of the communication part 35, the communication part 15, and the communication part 25, respectively. In the following description, the phrase "via the communication part(s)" in the description of the communication among the devices is omitted, for the sake of convenience.

Note that in the sequence diagrams described below, each step of the process performed in each of the devices is abbreviated as "step S". Further, each timing at which a signal, data, etc., is (are) transmitted or received between or among the devices is abbreviated as "timing T".

As illustrated in FIG. 4, the first printer 1 is capable of performing printing on a label generated simply using the predefined text and the template. In order to make the predefined text and the template usable, the user operates the first printer 1 previously so as to download the template DB and predefined text DB from the server 4 (timing T10). The downloaded template DB and predefined text DB are overwritten and stored in the memory 12 (step S12). That is, each of the template DB and the predefined text DB is updated to the latest version. Note that the download of the template DB and the predefined text DB by the first printer 1 may be performed only once, or may be performed periodically, or may be performed in a case where the template DB and the predefined text DB are updated.

The user starts an application on the PC 3. The application is a program for causing the first printer 1 to perform printing. The user performs an operation to use the first printer 1 in the template print mode. The PC 3 and the first printer 1 are connected to the network 8 via the LAN-I/F 35B and the LAN-I/F 15B. The PC 3 transmits a change instruction, to the first printer 1, to change to the template print mode, via the LAN-I/F 35B in accordance with the operation by the user (timing T14).

Upon receiving the change instruction via the LAN-I/F 15B, the first printer 1 transitions to the template print mode in accordance with the change instruction (step S16).

Next, the user operates the PC 3 to select, in the application, a predefined text to be printed on the label and a template to be applied to the predefined text. The PC 3 generates a print instruction including a predefined text ID of the selected predefined text, and a template ID of the selected template. In a case where any suitable text does not exist as the predefined text, the user can operate the operation part 33 to input an input text. In this case, the PC 3 generates a print instruction including input text data of the input text, and the template ID of the selected template.

Further, the application includes an option to display a time stamp indicating, for example, the date, time, etc., on the print image during the label printing. The time stamp is an image displaying the date, time, etc., in accordance with a predetermined format. In a case where the user enables the option to display the time stamp, an instruction to insert the time stamp into the print image is added to the print instruction.

The PC 3 transmits the generated print instruction to the first printer 1 (timing T18). The first printer 1 receives the print instruction transmitted from the PC 3. The first printer 1 reads the predefined text data, associated with the predefined text ID included in the print instruction, from the predefined text DB and stores the predefined text data in the memory 12. Alternatively, the first printer 1 stores the input text data included in the print instruction in the memory 12. The first printer 1 reads the template data, associated with the template ID included in the print instruction, from the template DB and stores the template data in the memory 12.

The first printer 1 virtually generates, on the memory 12, a print image displaying the predefined text data or the input text data in accordance with a layout defined in the template data (step S20). In a case where the print instruction does not include the instruction to insert a time stamp (step S22: NO), the first printer 1 prints the print image, generated in step S20, on the label (step S28).

In a case where the print instruction includes the instruction to insert the time stamp (step S22: YES), the first printer 1 obtains date-and-time information from the internal clock 17 (step S24). The date-and-time information represents, for example, the current date, time, etc. The first printer 1 generates the time stamp based on the obtained date-and-time information. The first printer 1 inserts the time stamp into the print image generated in step S20, thereby generating a print image including the time stamp (step S26). The first printer 1 prints the print image generated in step S20 or step S26 on the label (step S28).

In a case where the first printer 1 has completed the printing successfully (step S32) without any error occurring during the printing (step S30: NO), the first printer 1 transmits a printing completion notice to the PC 3 (timing T34). Upon receiving the printing completion notice, the PC 3 transmits, to the first printer 1, a release instruction to release the template print mode (timing T36). Upon receiving the release instruction, the first printer 1 releases the template print mode and transitions to the normal print mode (step S38). Thus, in a case where no error occurs during the printing by the first printer 1, the label printing by the first printer 1 is performed in the processes from timing T14 to step S38. Note that at least one of timing T34, timing T36, or step S38 may be omitted.

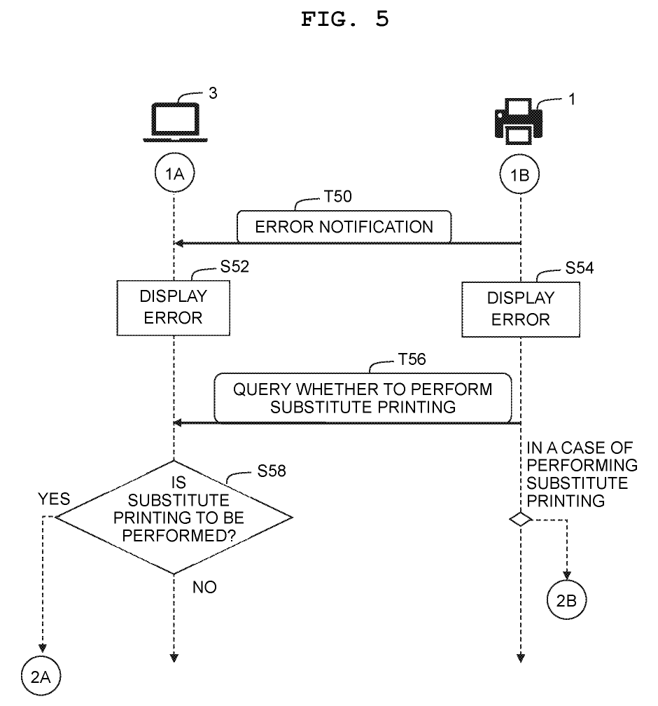

In a case where an error occurs during the label printing by the first printer 1 (step S30: YES), the printing by the first printer 1 is not completed. The flows of the processes in the PC 3 and the first printer 1 shift to lifeline 1A and lifeline 1B, respectively. As illustrated in FIG. 5, the first printer 1 transmits an error notification to the PC 3 to notify the PC 3 of the occurrence of error (timing T50). Upon receiving the error notification, the PC 3 displays a notice indicating that an error has occurred, in the application (step S52). Further, the first printer 1 also displays a notice indicating that an error has occurred, on the display part 14 (step S54). Note that at least one of timing T50, step S52, or step S54 may be omitted.

The error due to which the printing by the first printer 1 is not completed includes a first-kind error and a second-kind error. The first-kind error is relatively easily resolvable, such as in a case where the remaining amount of printable labels becomes zero or a jam occurs while the label is (being) conveyed. The second-kind error is mainly caused by any mechanical malfunction, such as a malfunction in a cutter, or a failure in the conveyance of the labels, and the second-kind error takes longer to be resolved than the first-kind error. The second-kind error is assumed to involve such a case where a part or component is to be replaced and/or repaired by a specialist. In a case where the error notice is displayed on the PC 3 and the first printer 1, the kind of the error is also displayed.

In a case where printing by the first printer 1 is not completed due to the error, the first printer 1 queries the PC 3 whether the user wishes to perform the substitute printing (timing T56). The PC 3 displays a prompt on the display part 34 asking the user whether to perform the substitute printing.

In a case where the user operates the operation part 33 to respond to the PC 3 that the user does not wish to perform the substitute printing (step S58: NO), the PC 3 enters a standby state. In this case, the first printer 1 remains in a state where the printing by the printer based on the print instruction received before the occurrence of the error is not completed. In this state, in a case where, for example, the first-kind error is resolved, the first printer 1 can print the print image stored in the memory 12 on the label and complete the printing. Note that in a case where the first printer 1 receives a new print instruction in a state where the error remains unresolved, the first printer 1 obtains the print instruction, but does not start the printing. In the embodiment, a state where the printing (by the first printer 1) is not completed includes both a state where printing is interrupted and a state where printing has not started.

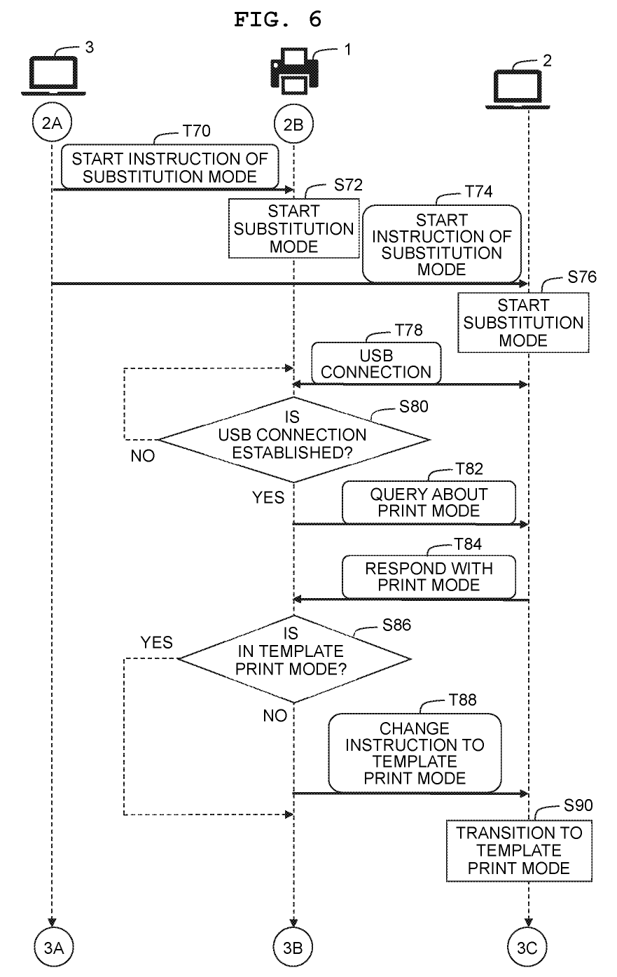

On the other hand, in a case where the user operates the operation part 33 to respond to the PC 3 that the user wish to perform the substitute printing (step S58: YES), the flows of the processes in the PC 3 and the first printer 1 shift from the lifeline 1A and the lifeline 1B to lifeline 2A and lifeline 2B, respectively. As illustrated in FIG. 6, the PC 3 transmits a start instruction to start the substitution mode to the first printer 1 and the second printer 2 (timing T70, timing T74). Upon receiving the start instruction, the first printer 1 and the second printer 2 each start the substitution mode (step S72, step S76). The substitution mode is a mode in which a process for performing the substitute printing is performed. Note that at least one of step S58, timing T70, step S72, timing T74, or step S76 may be omitted. In a case where step S58, timing T70, step S72, timing T74, and step S76 are omitted, the substitution mode may be automatically started in a case where the USB connection is established at timing T78. Further, in a case where step S58, timing T70, and timing T74 are omitted, the printer 1 and the printer 2 may accept, in step S72 and step S76, respectively, the start instruction to start the substitution mode, in response to the user operating the operation part 13 of the first printer 1.

In a case where substitution mode is started, the first printer 1 stands by until the second printer 2 is connected to the first printer 1 via USB (step S80: NO). The user disconnects the second printer 2, in which the substitution mode has been started, from being connected to the network 8. The user then uses the USB cable so as to connect the second printer 2 to the first printer 1 via USB (timing T78). Note that the second printer 2 may not be disconnected from the network 8. Further, the second printer 2 which is not originally connected to the network 8 may be used.

In the substitution mode, in a case where another device is connected to the first printer 1 via the USB cable, the first printer 1 attempts to communicatewith the another device via the USB cable. In a case where the second printer 2 which has transitioned to the substitution mode is connected to the first printer 1, the USB-I/F 15A of the first printer 1 identifies the connected device as a communicable device. Once the communication is established between the USB-I/F 15A of the first printer 1 and the USB-I/F 25A of the second printer 2, the first printer 1 determines that the second printer 2 has been connected to the first printer 1. The communication via the USB cable is started between the first printer 1 and the second printer 2. Further, the second printer 2 connects to the PC 3 via the network 8, with the first printer 1 as a bridge.

In a case where the second printer 2 is connected to the first printer 1 via USB (step S80: YES), the first printer 1 queries the second printer 2 about the current print mode of the second printer 2 (timing T82). The second printer 2 responds with the current print mode to the first printer 1 (timing T84).

In a case where the second printer 2 is already in the template print mode(step S86: YES), the flow of the process in the first printer 1 proceeds to step S92. In a case where the second printer 2 is not in the template print mode(step S86: NO), the first printer 1 transmits, to the second printer 2, a change instruction to change to the template print mode(timing T88). Upon receiving the change instruction, the second printer 2 transitions to the template print mode in accordance with the change instruction (step S90). The flows of the processes in the PC 3, the first printer 1 and the printer 2 shift to the lifeline 3A, the lifeline 3B and the lifeline 3C, respectively. Note that timing T82, timing T84, and step S86 may be omitted.

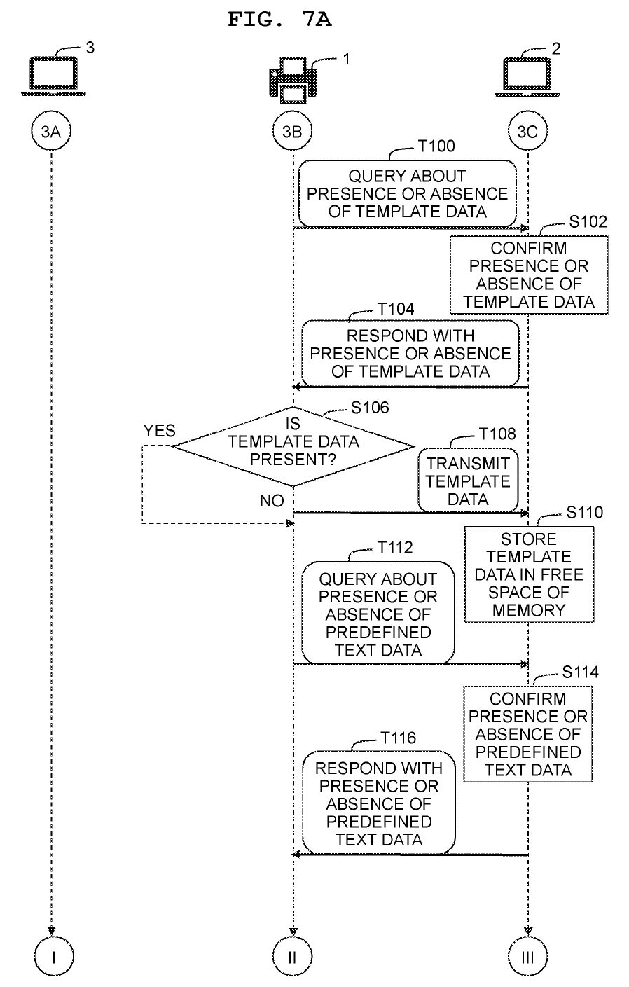

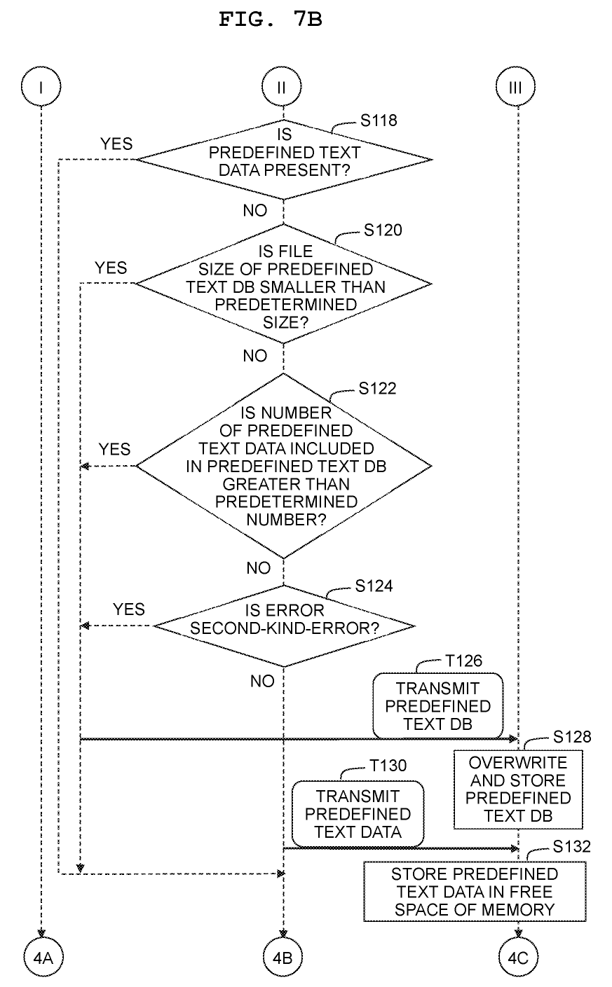

As illustrated in FIGS. 7A and 7B, the first printer 1 queries the second printer 2 whether the second printer 2 possesses template data associated with the template ID included in the print instruction (timing T100). The template data associated with the template ID included in the print instruction is template data to be used in the printing. The second printer 2 confirms whether the memory 22 stores the template data to be used in the printing (step S102). As described above, the second printer 2 may possess the template DB which is different from the template DB of the first printer 1 in version or may not possess the template DB. The second printer 2 respond whether the second printer 2 possesses the template data to be used in the printing to the first printer 1 (timing T104).

In the step S102, the second printer 2 may confirm whether the memory 22 stores matching template ID based on the template ID transmitted from the first printer 1. In the step S102, the second printer may confirm whether the memory 22 stores corresponding template data based on at least any of the template data transmitted from the first printer 1, a file name of the template data, or update date and time of the template data. The step S102 may be performed by the first printer 1. In a case where the first printer 1 performs the step S102, the second printer 2 may transmit at least any of the template ID, the template data, the file name of the template data, or the update date and time of the template data to the first printer 1.

In a case where a response from the second printer 2 is that the memory 22 of the second printer 2 does not store the template data to be used in the printing (step S106: NO), the first printer 1 transmits the template data to be used in the printing to the second printer 2 (timing T108). The second printer 2 stores the template data received from the first printer 1 in a free space of the memory 22 (step S110). On the other hand, in a case where the response from the second printer 2 is that the memory 22 of the second printer 2 stores the template data to be used in the printing (step S106: YES), the first printer 1 does not transmit the template data to be used in the printing to the second printer 2.

Next, the first printer 1 queries the second printer 2 whether the second printer 2 possesses predefined text data associated with the predefined text ID included in the print instruction (timing T112). The second printer 2 confirms whether the memory 22 stores the predefined text data associated with the predefined text ID (step S114). The second printer 2 responds presence or absence of the template data associated with the predefined text ID queried by the first printer 1, to the first printer 1 (timing T116).

In the step S114, the second printer 2 may confirm whether the memory 22 stores matching predefined text ID based on the predefined text ID transmitted from the first printer 1. In the step S114, the second printer may confirm whether the memory 22 stores corresponding predefined text data based on at least any of the predefined text data transmitted from the first printer 1, a file name of the predefined text data, or update date and time of the predefined text data. The step S114 may be performed by the first printer 1. In a case where the first printer 1 performs the step S114, the second printer 2 may transmit at least any of the predefined text ID, the predefined text data, the file name of the predefined text data, or the update date and time of the predefined text data to the first printer 1.

In a case where a response from the second printer 2 is that the memory 22 of the second printer 2 stores corresponding predefined text data (step S118: YES), the first printer 1 does not transmit the predefined text data to the second printer 2. The flow of the processes in the first printer 1 shifts from the lifeline 3B to lifeline 4B.

In a case where a response from the second printer 2 is that the memory 22 of the second printer 2 does not store the corresponding predefined text data (step S118: NO), the first printer 1 determines whether each of the following three conditions (first condition, second condition, third condition) is satisfied. In a case where the first printer 1 determines that any one of the three conditions is satisfied, the first printer 1 transmits the predefined text DB to the second printer 2. In a case where the first printer 1 determines that none of the three conditions are satisfied, the first printer 1 transmits the predefined text data to the second printer 2. Note that the first printer 1 may determine whether at least one of the three conditions is satisfied.

The first condition is such a condition that the file size of the predefined text DB stored in the memory 12 of the first printer 1 is smaller than a predetermined size. In a case where the file size of the predefined text DB is smaller than the predetermined size, the transmittance of the predefined text DB from the first printer 1 to the second printer 2 does not take much time, and the load on the communication is relatively small. Therefore, in a case where the first condition is satisfied (step S120: YES), the first printer 1 transmits the predefined text DB to the second printer 2 (timing T126).

The second condition is such a condition that the number of the predefined text data included in the predefined text DB is greater than a predetermined number. In a case where the number of the predefined text data included in the predefined text DB is greater than the predetermined number, the load on the communication increases each time the predefined text data is transmitted from the first printer 1 to the second printer 2. In this situation, in a case where the second printer 2 has the predefined text DB, the transmittance of the predefined text ID singly from the first printer 1 to the second printer 2 is sufficient, thereby reducing the load on the communication which would otherwise occur each time the predefined text data is transmitted. Therefore, in a case where the second condition is satisfied (step S122: YES), the first printer 1 transmits the predefined text DB to the second printer 2 (step S126).

The third condition is such a condition that an error occurring in the first printer 1 is the second-kind error. The second-kind errors take longer to be resolved than the first-kind errors. That is, the second printer 2 is highly likely to continuously be used as a substitute for the first printer 1. Also in this situation, in a case where the second printer 2 has the predefined text DB, the transmittance of the predefined text ID singly from the first printer 1 to the second printer 2 is sufficient, thereby reducing the load on the communication which would otherwise occur each time the predefined text data is transmitted. In a case where the third condition is satisfied (step S124: YES), the first printer 1 transmits the predefined text DB to the second printer 2 (step S126).

The second printer 2 overwrites and stores the predefined text DB received from the first printer 1 in the memory 22 (step S128). In a case where the first condition is not satisfied (step S120: NO), the second condition is not satisfied (step S122: NO), and the third condition is not satisfied (step S124: NO), the first printer 1 transmits the predefined text data to the second printer 2 (timing T130). The second printer 2 stores the predefined text DB or the predefined text data received from the first printer 1 in a free space of the memory 22 (step S132). The flows of the processes in the PC 3, the first printer 1, and the second printer 2 shift from the lifeline 3A, the lifeline 3B and the lifeline 3C to lifeline 4A, lifeline 4B and lifeline 4C, respectively.

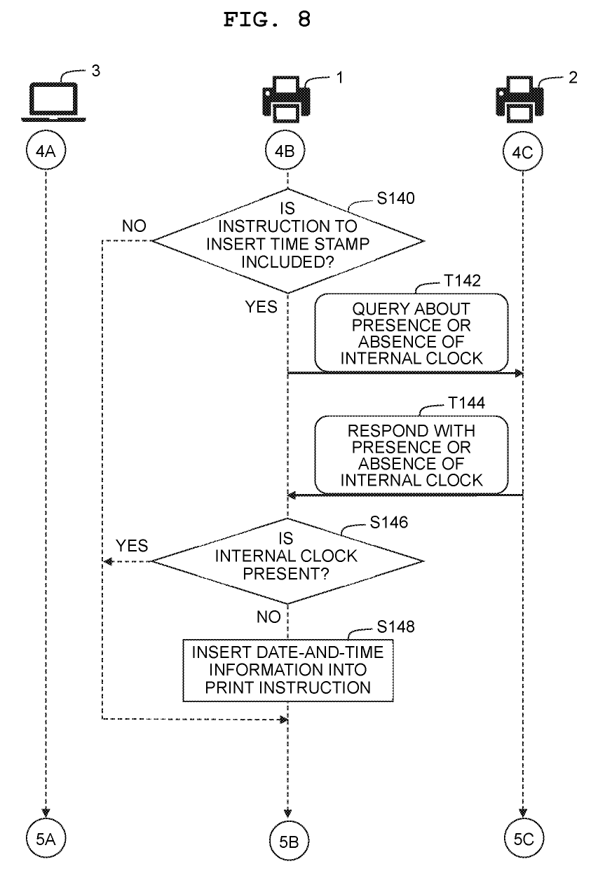

As illustrated in FIG. 8, in a case where the print instruction received from the PC 3 at timing T18 does not include an instruction to insert time stamp (step S140: NO), the first printer 1 transmits the print instruction to the second printer 2 (timing T150). In a case where the print instruction includes the instruction to insert the time stamp (step S140: YES), the first printer 1 queries the second printer 2 whether the second printer possesses the internal clock 27 (timing T142). The second printer 2 responds whether the second printer 2 possesses the internal clock 27 to the first printer 1 (timing T144).

Step S140, timing T142, timing T144, and step S146 may be omitted. The first printer 1 may query the second printer 2 a version of firmware at timing T142, and the second printer 2 may respond with the version of the firmware at timing T144. In this case, the second printer 2 may confirm whether the second printer 2 possesses the internal clock 27 by referring to a list of versions of the firmware including the internal clock 27.

In a case where the first printer 1 receives a response that the second printer 2 possesses the internal clock 27 (step S146: YES), the first printer 1 transmits the print instruction to the second printer 2 (timing T150). In a case where the first printer 1 receives a response that the second printer 2 does not possess the internal clock 27 (step S146: NO), the first printer 1 add the date-and-time information obtained by step S24 to the print instruction (step S148). The first printer 1 stores information as to whether the second printer 2 possesses the internal clock 27 in the memory 12. The flows of the processes in the PC 3, the first printer 1, and the second printer 2 shift from the lifeline 4A, the lifeline 4B and the lifeline 4C to lifeline 5A, lifeline 5B and lifeline 5C, respectively.

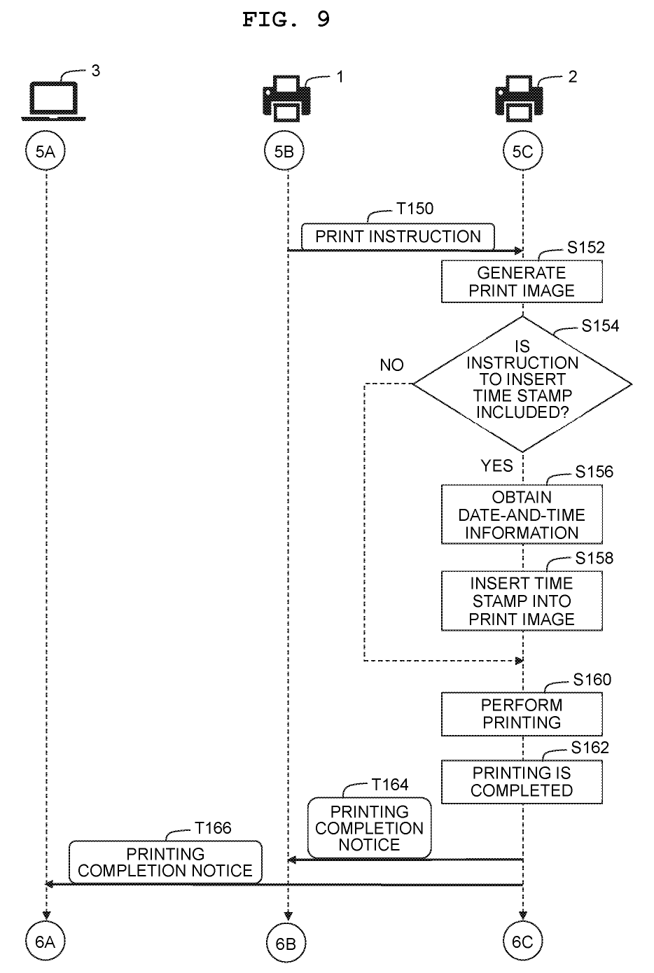

As illustrated in FIG. 9, the first printer 1 transmits the print instruction including the date-and-time information to the second printer 2 (timing T150).

The second printer 2 receives the print instruction transmitted from the first printer 1. The predefined text data has been stored in the memory 22 by step S132. In a case where the memory 22 does not store the predefined text data, the predefined text DB including the predefined text data associated with the predefined text ID has already been stored in the memory 22. Or, the predefined text DB has been stored in the memory 22 by step S128. In this case, the second printer 2 extracts the predefined text data associated with the predefined text ID included in the print instruction from the predefined text DB, and stores the predefined text data in the memory 22.

The template data has been stored in memory 22 by step S110. In a case where the memory 22 does not store the template data, the template DB including the template data associated with the template ID has already been stored in the memory 22. In this case, the second printer 2 extracts the template data associated with the template ID included in the print instruction from the template DB, and stores the template data in the memory 22. In a case that the print instruction includes input text data, the second printer 2 stores the input text data in the memory 22.

The second printer 2 virtually generates, on the memory 22, a print image displaying the predefined text data or the input text data in accordance with a layout defined in the template data (step S152). In a case where the print instruction does not include the instruction to insert the time stamp (step S154: NO), the second printer 2 prints the print image generated in step S152 on the label (step S160). Note that steps S154, S156, and S158 may be omitted.

In a case where the print instruction includes the instruction to insert the time stamp (step S154: YES), the second printer 2 obtains the date-and-time information (step S156). In a case where the second printer 2 has the internal clock 27, the second printer 2 obtains the date-and-time information from the internal clock 27. In a case where the second printer 2 does not have the internal clock 27, the second printer 2 obtains the date-and-time information added to the print instruction in step S148. The second printer 2 generates the time stamp based on the obtained date-and-time information. The second printer 2 inserts the time stamp into the print image generated in step S152, thereby generating a print image including the time stamp (step S158).

The second printer 2 prints the print image generated in step S152 or step S158, on the label (step S160). Upon completing the printing (step S162), the second printer 2 transmits the printing completion notice to the first printer 1 (timing T164). Further, the second printer 2 transmits the printing completion notice to the PC 3 via the network 8 to which the second printer 2 is connected via the first printer 1 as the bridge (timing T166). The flows of the processes in the PC 3, the first printer 1, and the second printer 2 shift from the lifeline 5A, the lifeline 5B and the lifeline 5C to lifeline 6A, lifeline 6B and lifeline 6C, respectively. Note that at least one of step S164 or step S166 may be omitted.

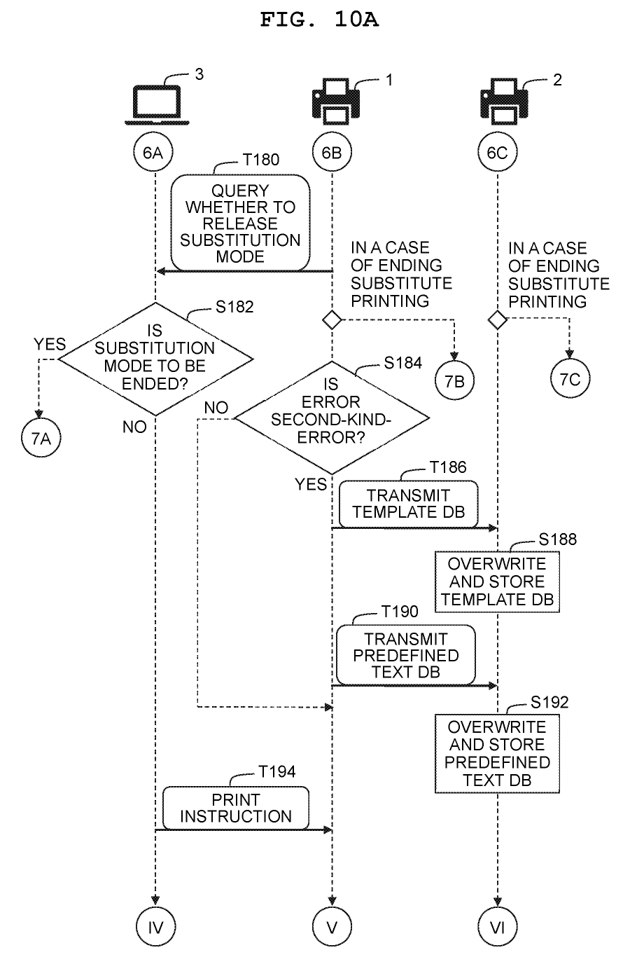

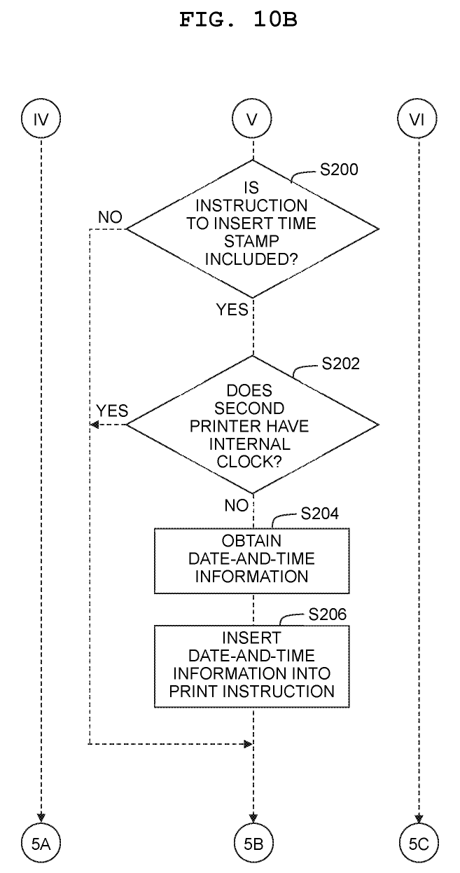

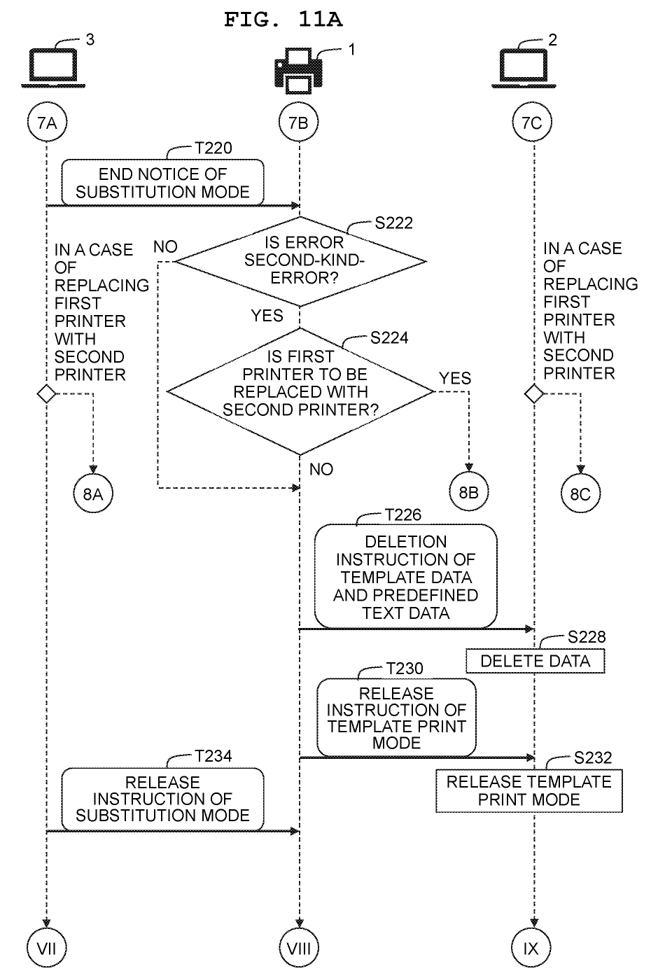

As illustrated in FIGS. 10A and 10B, the first printer 1 queries the PC 3 as to whether to release the substitution mode (timing T180). In a case where the user operates the operation part 33 to respond to the first printer 1 that the user does not wish to release the substitution mode in order to continue the substitute printing (step S182: NO), the PC 3 stands by for the printing to be performed on the next label. In a case where the error occurred in the first printer 1 is the first-kind error (step S184: NO), the first printer 1 stands by to receive a new print instruction from the PC 3. Note that timing T180 and step S182 may be omitted. Further, the process of step S182 may be performed by the first printer 1.

In a case where the error occurred in the first printer 1 is the second-kind error (step S184: YES), the first printer 1 transmits the template DB to the second printer 2 (timing T186). The second printer 2 overwrites and stores the template DB received from the first printer 1 in the memory 22 (step S188). Further, the first printer 1 transmits the predefined text DB to the second printer 2 (timing T190). The second printer 2 overwrites and stores the predefined text DB received from the first printer 1 in the memory 22 (step S192). In the processes from timing T186 to step S192, the second printer 2 consequently has the template DB and the predefined text DB which are the same as the template DB and the predefined text DB of the first printer 1. In the processes from timing T186 to step S192, the template DB and the predefined text DB include a template ID and a predefined text ID, respectively, which are different from the template ID and the predefined text ID corresponding to the print instruction at timing T18. Note that at least any of step S184, timing T186, or timing T190 may be omitted.

In a case where the new print instruction is generated in the PC 3, the PC 3 transmits the new print instruction to the first printer 1 (timing T194). In a case where the print instruction received from the PC 3 at timing T18 does not include an instruction to insert the time stamp (step S200: NO), the flow of the process in the first printer 1 shift to the lifeline 5B. In a case where the print instruction includes the instruction to insert the time stamp (step S200: YES), the first printer 1 confirms the information as to whether the second printer 2 possesses the internal clock 27 stored in the memory 12.

In a case where the second printer 2 possesses the internal clock 27 (step S202: YES), the flow of the process in the first printer 1 shift to the lifeline 5B. In a case where the second printer 2 does not possess the internal clock 27 (step S202: NO), the first printer 1 obtains the date-and-time information from the internal clock 17 and adds the date-and-time information to the print instruction (step S206). The flows of the processes in the PC 3, the first printer 1, and the second printer 2 shift to the lifeline 5A, the lifeline 5B and the lifeline 5C, respectively. The second printer 2 receives the print instruction from the first printer 1 and performs the substitute printing for the first printer 1. Note that steps S200 and S202 may be omitted.

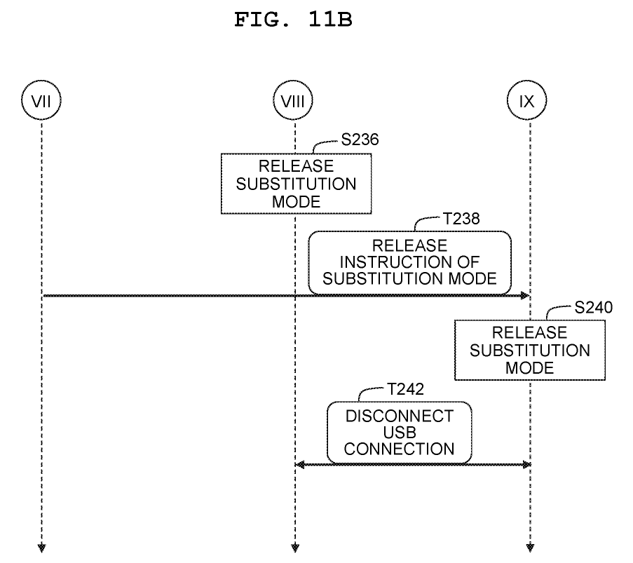

In a case where the user responds to the first printer 1 in step S182 to release the substitute printing so as to end the substitution mode (step S182: YES), the flows of the processes in the PC 3, the first printer 1, and the second printer 2 shift from the lifeline 6A, the lifeline 6B and lifeline 6C to lifeline 7A, lifeline 7B, and lifeline 7C, respectively. As illustrated in FIGS. 11A and 11B, the PC 3 transmits an end notice for ending the substitution mode to the first printer 1 (timing T220). Note that timing T220 may be omitted.

Upon receiving the end notice for ending the substitution mode, the first printer 1 determines whether the error which has occurred is the first-kind error or the second-kind error (step S222). In a case where the first printer 1 determines that the error is the second-kind error (step S222: YES), the first printer 1 accepts, from the PC 3, a response regarding whether to replace the first printer 1 with the second printer 2 and to cause the second printer to perform the printing (step S224). That is, the first printer 1 accepts a response, from the PC 3, regarding whether the printing is to be performed directly from the second printer 2 as a replacement device replacing the first printer 1, rather than causing the second printer 2 to perform the substitute printing for the first printer 1. The first printer 1 causes the display part 14 to display a screen to accept a response regarding whether the first printer 1 is to be replaced with the second printer 2 as the replacement device, and the first printer 1 accepts a response from the user, via the operation of the operation part 13 by the user. Note that at least one of step S222 or step S224 may be omitted.

In a case where the error is the first-kind error (step S222: NO), or in a case where the user responds that the user does not wish to replace the first printer 1 with the second printer 2 as the replacement device (step S224: NO), the first printer 1 transmits, to the second printer 2, a deletion instruction to delete the template data and the predefined text data stored in the substitute printing (timing T226). Upon receiving the deletion instruction from the first printer 1, the second printer 2 deletes the template data and predefined text data stored in the memory 22 (step S228). Note that at least one of timing T226 or step S228 may be omitted.

The first printer 1 transmits, to the second printer 2, the release instruction to release the template print mode (timing T230). Upon receiving the release instruction, the second printer 2 releases the template print mode and transitions to the normal print mode (step S232). Note that at least one of timing T230 or step S232 may be omitted.

The PC 3 transmits the release instruction to release the substitution mode to the first printer 1 and the second printer 2 (timing T234, timing T238). Upon receiving the release instruction, each of the first printer 1 and the second printer 2 releases the substitution mode (step S236, step S240). The user disconnects the USB cable connecting the first printer 1 and the second printer 2, disconnecting the USB connection (timing T242) between the first and second printers 1 and 2. In this manner, in a case where the substitution mode is released without replacing the first printer 1 with the second printer 1 as the replacement device, the second printer 2 deletes the template data and the predefined text data received from the first printer 1. Note that at least one of timing T234 or timing T238 may be omitted. In this case, upon detecting the disconnection of the USB connection at timing T242, the first printer 1 may perform the process of step S236 and the second printer 2 may perform the process of step S240.

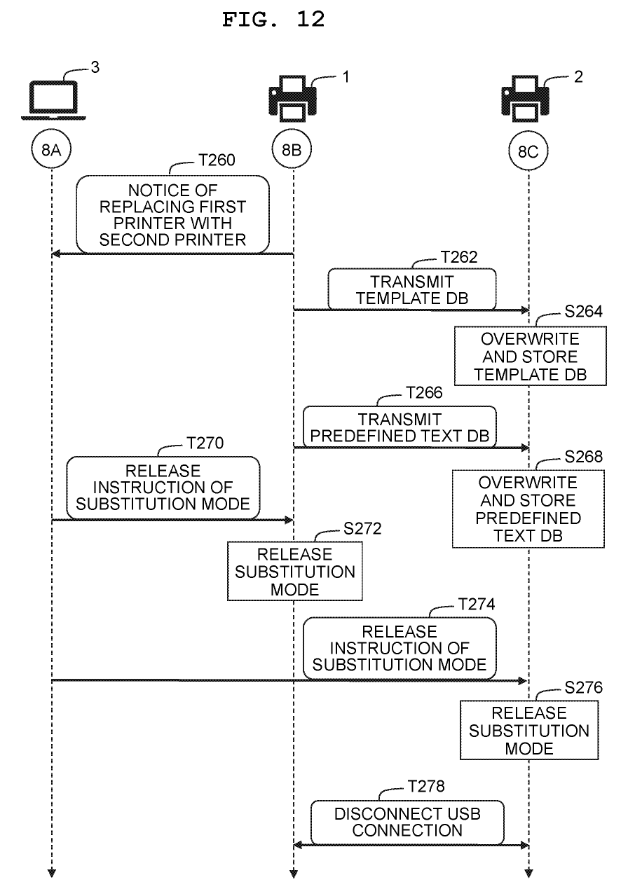

In a case where the substitution mode is to be released, and wherethe user responds indicating that the first printer 1 to be replaced with the second printer 2 as the replacement device (step S224: YES), the flows of the processes in the PC 3, the first printer 1, and the second printer 2 shift from the lifeline 7A, the lifeline 7B and the lifeline 7C to lifeline 8A, lifeline 8B and lifeline 8C, respectively. As illustrated in FIG. 12, the first printer 1 transmits, to the PC 3, a notice to notify the PC 3 that the first printer 1 is to be replaced with the second printer 2 as the replacement device (timing T260).

The first printer 1 transmits the template DB to the second printer 2 (timing T262). The second printer 2 overwrites and stores the template DB received from the first printer 1 in the memory 22 (step S264). Further, the first printer 1 transmits the predefined text DB to the second printer 2 (timing T266). The second printer 2 overwrites and stores the predefined text DB, received from the first printer 1, in the memory 22 (step S268). In the processes from timing T262 to step S268, the second printer 2 consequently has the same template DB and the predefined text DB as the template DB and the predefined text DB of the first printer 1. In the processes from timing T262 to step S268, the template DB and the predefined text DB include a template ID and a predefined text ID, respectively, which are different from the template ID and the predefined text ID corresponding to the print instruction at timing T18.

The PC 3 transmits the release instruction to release the substitution mode to the first printer 1 and the second printer 2 (timing T270, timing T274). Upon receiving the release instruction, each of the first printer 1 and the second printer 2 releases the substitution mode (step S272, step S276). Thus, in a case where the first printer 1 is to be replaced with the second printer 2 as the replacement device in such a manner, the second printer 2 consequently has the template DB and predefined text DB which are the same as the template DB and the predefined text DB of the first printer 1 during timing T270 to step S276. The user disconnects the USB cable connecting the first printer 1 and the second printer 2, disconnecting the USB connection (timing T278). The PC 3 transmits a print instruction to the second printer 2 connected via the network 8. The second printer 2, acting as a replacement device for the first printer 1, is then capable of performing printing on the label. Note that timing T260 may be omitted. Further, at least one of timing T270 or timing T274 may be omitted. In this case, each of the first printer 1 and the second printer 2 may detect the disconnection of the USB connection at timing T278, and the first printer 1 may perform the process of step S272 and the second printer 2 may perform the process of step S276.

As described above, the first printer 1 queries the second printer 2 whether the second printer 2 possesses the template data to be used in the printing. In a case where the second printer 2 possesses the template data to be used in the printing, the first printer 1 transmits the print instruction and does not transmit the template data to the second printer 2. Thus, the first printer 1 contributes to causing the second printer 2 to print, on the label, the appropriate print image based on the print instruction.

In a case where the second printer 2 does not possess the template data to be used in the printing, the first printer 1 transmits the template data together with the print instruction to the second printer 2. Thus, the first printer 1 contributes to causing the second printer 2 to print, on the label, the appropriate print image based on the print instruction.

In a case where the second printer 2 does not possess the template data to be used in the printing, the first printer 1 transmits the template data together with the print instruction to the second printer 2. After transmitting the print instruction and the template data to the second printer 2, the first printer 1 transmits the template DB to the second printer 2. That is, during the substitute printing performed for the first time, the first printer 1 transmits the print instruction and the template data to the second printer 2 so that the substitute printing can be performed smoothly. Further, for the substitute printing performed subsequently, the first printer 1 transmits the template DB to the second printer 2 so that the substitute printing can be performed further smoothly. Therefore, the first printer 1 contributes to causing the second printer 2, as the substitute for the first printer 1, to print, on the label, the appropriate print image based on the print instruction.

The predefined text data is associated with the predefined text ID in the predefined text DB. In a case where the second printer 2 does not possess the predefined text data to be used in the printing, the first printer 1 identifies the predefined text data from the predefined text DB based on the predefined text ID included in the print instruction. The first printer 1 transmits the identified predefined text data together with the print instruction to the second printer 2. Thus, the first printer 1 contributes to causing the second printer 2 to print, on the label, the appropriate print image based on the print instruction.

In a case where the second printer 2 does not possess the predefined text data to be used in the printing, the first printer 1 transmits the print instruction and the predefined text data to the second printer 2. After transmitting the print instruction and the predefined text data, the first printer 1 transmits the predefined text DB to the second printer 2. That is, during the substitute printing performed for the first time, the first printer 1 transmits the print instruction and the predefined text data to the second printer 2 so that the substitute printing can be performed smoothly. Further, for the substitute printing performed subsequently, the first printer 1 transmits the predefined text DB to the second printer 2 so that the substitute printing can be performed further smoothly. Therefore, the first printer 1 contributes to causing the second printer 2, as the substitute for the first printer 1, to print, on the label, the appropriate print image based on the print instruction.

The first condition is such a condition that the file size of the predefined text DB is smaller than the predetermined size. The predefined text DB with a file size equal to or larger than the predetermined size takes longer to be transmitted from the first printer 1 to the second printer 2, as compared to the predefined text DB of which size is smaller than the predetermined size. Therefore, in a case where the first condition is not satisfied, the necessity to transmit the predefined text DB to the second printer 2 is low. Thus, the first printer 1 is configured to transmit the predefined text DB to the second printer 2 in a case where the first condition is satisfied, thereby contributing to causing the second printer 2 to perform the substitute printing smoothly.

The second condition is such a condition that the number of the predefined text data included in the predefined text DB is greater than the predetermined number. In a case where the number of the predefined text data associated with the predefined text IDs is less than the predetermined number, the transmission of the predefined text data to the second printer 2 each time the printing is performed does not take significant time. Therefore, in a case where the second condition is not satisfied, the necessity to transmit the predefined text DB to the second printer 2 in advance is low. Thus, the first printer 1 is configured to transmit the predefined text DB to the second printer 2 in a case where the second condition is satisfied, thereby contributing to causing the second printer 2 to perform the substitute printing smoothly.

The third condition is such a condition that the error occurring in the first printer 1 is the second-kind error. In a case where the error occurring in the first printer 1 is the first-kind error, resolving the error does not take time. That is, using the second printer 2 as the substitute for the first printer 1 is merely for the short period until the error is resolved. Therefore, in a case where the third condition is not satisfied, the necessity of transmitting the predefined text DB in advance to the second printer 2 is low. Thus, the first printer 1 is configured to transmit the predefined text DB to the second printer 2 in a case where the third condition is satisfied, thereby contributing to performing the substitute printing smoothly.

In a case where the input text per se rather than the predefined text is printed on the label, the first printer 1 receives the print instruction including input text data from the PC 3. Upon receiving the print instruction including the input text data from the printer 1, the second printer 2 is capable of generating a print image in which the input text is applied to the template. Therefore, the first printer 1 contributes to causing the second printer 2, as the substitute for the first printer 1, to print an appropriate print image based on the print instruction on the label.

In a case where the second printer 2 is to be used to replace the first printer 1, the first printer 1 transmits the template DB of the first printer 1 to the second printer 2. Therefore, t he second printer 2 is capable of generating an appropriate print image based on the print instruction. Thus, the first printer 1 contributes to causing the second printer 2, as the substitute for the first printer 1, to print an appropriate print image based on the print instruction on the label.

In a case where the second printer 2 is used to replace the first printer 1, the first printer 1 transmits the predefined text DB to the second printer 2. Therefore, the second printer 2 is capable of generating an appropriate print image based on the print instruction. Thus, the first printer 1 contributes to causing the second printer 2, as the substitute for the first printer 1, to print an appropriate print image based on the first data or the second data, on the label.

In a case where the error due to which the printing by the first printer 1 is not completed is the first-kind error, the error is expected to be resolved quickly. Therefore, the second printer 2 is not expected to be used as the replacement of the first printer 1 continuously for a long period of time. In a case where the error due to which the printing by the first printer 1 is not completed is the second-kind error, the resolution of the error is expected to take time. In this case, the second printer 2 is used to replace the first printer 1. Thus, the first printer 1 is replaced with the second printer 2, thereby contributing to printing an appropriate print image based on the print instruction, on the label.

The USB-I/F 15A of the first printer 1 attempts to communicate with the device connected to the first printer 1 via the USB cable. In a case where the connection is established between the USB-I/F 15A and the USB-I/F 25A, the first printer 1 determines that the second printer 2 is connected the first printer 1. With this, the first printer 1 is able to easily determine the connection with the second printer 2. Therefore, the first printer 1 contributes to causing the second printer 2, as the substitute for the first printer 1, to print, on the label, the appropriate print image based on the print instruction.

In a case where the second printer 2 has the internal clock 27, the second printer 2 is capable of obtaining the date-and-time information from the internal clock 27. Even in a case where the second printer 2 does not have the internal clock 27, the second printer 2 is capable of obtaining the date-and-time information, which has been obtained by the first printer 1 from the internal clock 17, from the first printer 1. Thus, the second printer 2 is capable of generating the print image, in which the date-and-time information is added, by applying the predefined text or the input text to the template. Therefore, the first printer 1 contributes to causing the second printer 2, as the substitute for the first printer 1, to print the appropriate print image based on the print instruction, on the label.

In a case where the first printer 1 is connected to the second printer 2, the first printer 1 is capable of querying the second printer 2 about the print mode of the second printer 2. In a case where the second printer 2 is not in the template print mode, the first printer 1 is capable of instructing the second printer 2 to transition to the template print mode. Consequently, the second printer 2 is capable of generating a print image in which the predefined text or the input text is applied to the template. Thus, the first printer 1 contributes to causing the second printer 2, as the substitute for the first printer 1, to print the appropriate print image based on the print instruction, on the label.

The first printer 1 is capable of querying the user as to whether to replace the first printer 1 with the second printer 2. In a case where the user does not wish to replace the first printer 1 with the second printer 2, the first printer 1 is capable of cancelling and releasing the transition of the second printer 2 to the template print mode. With this, the first printer 1 is capable of returning the second printer 2 to be in the mode before the second printer 2 has been connected to the first printer 1.

The second printer 2 receives, from the first printer 1, query as to whether the second printer 2 possesses the template data to be used in the printing. In a case where the second printer 2 possesses the template data to be used in the printing, the second printer 2 receives the print instruction from the first printer 1. Thus, the second printer 2 contributes to printing, on the label, the appropriate print image based on the print instruction, as the substitute for the first printer 1.

In a case where the second printer 2 does not possess the template data to be used in the printing, the second printer 2 receives the template data together with the print instruction from the first printer 1. Thus, the second printer 2 contributes to printing, on the label, the appropriate print image based on the print instruction, as the substitute for the first printer 1.

The second printer 2 overwrites and stores the template DB and the predefined text DB received from the first printer 1 in the memory 22. Therefore, the latest template DB and the latest predefined text DB are stored in the memory 22. The second printer 2 is capable of extracting an appropriate predefined text and an appropriate template from the latest predefined text DB and the latest template DB, respectively. Therefore, the second printer 2 contributes to printing an appropriate print image based on the print instruction on the label, as the substitute for the first printer 1.

Even in a case where the second printer 2 does not have the internal clock 27, the second printer 2 is capable of receiving the date-and time information, which has been obtained by the first printer 1 from the internal clock 17, from the first printer 1. Therefore, the second printer 2 is capable of generating the print image in which the predefined text or the input text is applied to the template and to which the date-and-time information is added. Thus, the second printer 2 contributes to printing, on the label, an appropriate print image based on the print instruction, as the substitute for the first printer 1.

In the embodiment described above, the label is an example of a "print medium" of the present disclosure. The first printer 1 is an example of a "printing apparatus" in the first aspect and the third aspect of the present disclosure, and is an example of "another printing apparatus" in the second aspect of the present disclosure. The input text and the predefined text are each an example of "print content" of the present disclosure.

The memory 12 is an example of a "first memory" of the present disclosure. The printing part 16 is an example of a "printing mechanism" in the first aspect and the third aspect of the present disclosure. The communicating part 15 is an example of a "communication interface" in the first aspect and the third aspect of the present disclosure. The CPU 11 is an example of a "processor" in the first aspect and the third aspect of the present disclosure.

The inputted text data and the predefined text data are each an example of "print content data" in the present disclosure. The inputted text per se and the predefined text ID are each an example of "related information" in the present disclosure. The process in which the first printer 1 receives the print instruction at timing T18 is an example of an "obtaining process" of the present disclosure. The process in which the first printer 1 performs printing in step S28 is an example of a "first printing process" of the present disclosure.

The second printer 2 is an example of the "another printing apparatus" in the first aspect and the third aspect of the present disclosure, and an example of the "printing apparatus" in the second aspect of the present disclosure. The process in which the first printer 1 queries the second printer 2 as to whether the second printer 2 possesses the template data at timing T100 is an example of a "first querying process" of the present disclosure. The process in which the first printer 1 transmits the print instruction to the second printer 2 at timing T150, the process in which the first printer 1 transmits the print instruction to the second printer 2 at timing T108, and the process in which the first printer 1 transmits the predefined text DB to the second printer 2 at timing T126 are an example of a "first transmitting process" of the present disclosure. Further, the process in which the first printer 1 transmits the predefined text data to the second printer 2 at timing T130, timing T190, and timing T266, and the process in which the first printer 1 transmits the template DB to the second printer 2at timing T190 and timing T262, are also examples of the "first transmitting process" of the present disclosure.

The process in which the first printer 1 transmits the template DB to the second printer 2 at timing T186 and timing T262 is an example of a "second transmitting process" of the present disclosure. The predefined text ID is an example of "identification information" of the present disclosure. The predefined text DB is an example of a "print content database" of the present disclosure.

The process in which the first printer 1 transmits the predefined text DB to the second printer 2 at timing T190 is an example of a "third transmitting process" of the present disclosure. The process in which the first printer 1 accepts the response (, from the PC 3,) as to whether the first printer is to be replaced with the second printer 2 at step S224 is an example of a "first accepting process" of the present disclosure. The various devices including the second printer 2 are each an example of "another printing apparatus" of the present disclosure. The USB-I/F 15A is an example of a "connection interface" of the present disclosure.

The process in which the first printer 1 obtains the date-and-time information in step S24 is an example of a "date-and-time obtaining process" of the present disclosure. The process in which the first printer 1 queries the second printer 2 about the presence or absence of the internal clock at timing T142 is an example of a "second querying process" of the present disclosure.

The memory 22 is an example of a "memory" of the another printing apparatus in the first aspect of the present disclosure. The process in which the first printer 1 queries the second printer 2 about the print mode of the second printer 2 at timing T82 is an example of a "third querying process" of the present disclosure. The process in which the first printer 1 transmits, to the second printer 2, the change instruction to the template print mode at timing T88 is an example of a "mode transition process" of the present disclosure. The process in which the first printer 1 transmits, to the second printer 2, the release instruction to release the template print mode at timing T230 is an example of a "transition canceling process" of the present disclosure.

The memory 22 is an example of the "second memory" in the second aspect of the present disclosure. The communication part 25 is an example of the "communication interface" in the second aspect of the present disclosure. The printing part 26 is an example of the "printing mechanism" in the second aspect of the present disclosure. The CPU 21 is an example of the "processor" in the second aspect of the present disclosure.

The process in which the second printer 2 receives the query as to whether the second printer 2 possesses the template data at timing T100 is an example of a "secondaccepting process" of the present disclosure. The process in which the second printer 2 responds as to whether the second printer 2 possesses the template data at timing T104 is an example of the "second responding process" of the present disclosure. The process in which the second printer 2 receives the print instruction at timing T150 is an example of the "second receiving process" of the present disclosure. The process in which the second printer 2 performs printing in step S160 is an example of a "second printing process" of the present disclosure. The process in which the second printer 2 overwrites and stores the template DB and the predefined text DB in the memory 22 in steps S188, S192, S264, and S268 is an example of a "storing process" of the present disclosure.

The present disclosure is not limited to the embodiment described above, and various modifications are possible. The PC 3 is not limited to a personal computer. The PC 3 may also be, for example, a smartphone, a PDA, a tablet terminal, etc. The first printer 1 and the second printer 2 may use, for example, an ASIC, a FPGA (Field Programmable Gate Array), etc., as the processor, rather than using the CPU 11 and the CPU 21, respectively. Although the predefined text or the input text is applied to the template, the present disclosure is not limited to this. With respect to a template using a layout displaying two or more predefined texts or two or more input texts, the two or more predefined texts or the two or more input texts may be applied to the template. The input text or the predefined text is defined as the print content, but an image may also be included in the print content.

Although the first printer 1 and the second printer 2 communicates with each other via the USB cable in a case where the substitute printing is performed, the LAN-I/F 15B of the first printer 1 and the LAN-I/F 25B of the second printer 2 may be connected to each other via a LAN cable so as to cause the first printer 1 and the second printer 2 to communicate peer-to-peer.

The communication part 15 of the first printer 1 and the communication part 25 of the second printer 2 may each include a wireless LAN connection interface. In a case where the substitute printing is performed, the first printer 1 and the second printer 2 may be connected with each other in the wireless LAN ad hoc mode, and may be communicated with each other peer-to-peer in a case where the substitute printing is performed. Alternatively, in a case where the substitute printing is performed, the first printer 1 and the second printer 2 may be connected with each other via Wi-Fi Direct of the wireless LAN, and may be communicated with each other peer-to-peer. The communication part 15 of the first printer 1 and the communication part 25 of the second printer 2 may each include a Bluetooth connection interface (Bluetooth is registered trademark of Bluetooth SIC. Inc.). In a case where the substitute printing is performed, the first printer 1 and the second printer 2 may be connected to each other via Bluetooth.

The first printer 1 may transmit the template data to the second printer 2 in the substitute printing, rather than transmitting the template DB to the second printer 2. The first printer 1 may transmit the prescribed text data to the second printer 2 in the substitute printing, rather than transmitting the prescribed text DB to the second printer 2. The first printer 1 may not add the date-and-time information to the print image. Alternatively, the PC 3 may include the date-and-time information in the print instruction and transmit, to the first printer 1, the print instruction in which the data-and-time information is included. The second printer 2 may use the date-and-time information included in the print instruction in the substitute printing.

The print substitution system 100 may not include the PC 3. In this case, the first printer 1 may obtain the print instruction generated by the user operating the operation part 13, and may perform printing on the label and may cause the second printer 2 to perform the substitute printing for the first printer 1. Further, a reading device configured to read a code image in which the template ID and the predefined text ID are encoded may be connected to the first printer 1. In this case, the first printer 1 may obtain the print instruction from this reading device. Furthermore, the notice, etc., transmitted by the first printer 1 to the PC 3 in the embodiment may be displayed on the display part 14. The query, etc., transmitted by the first printer 1 to the PC 3 in the embodiment may be displayed on the display part 14, and the operation part 13 may accept input of the response by the user.

In step S112, the first printer 1 queries the second printer 2 whether the second printer 2 possesses the predefined text data associated with the predefined text ID included in the print instruction. However, the first printer 1 queries the second printer 2 whether the second printer 2 possesses the predefined text DB which includes the predefined text ID included in the print instruction. In a case where the response from the second printer 2 is that the second printer 2 does not possess the predefined text DB, the first printer 1 may transmit the predefined text DB to the second printer 2. The second printer 2 is capable of printing the print image in which the predefined text is applied to the template, by receiving the print instruction including the predefined text ID from the first printer 1.

What is claimed is:

1. A printing apparatus, comprising:
a first memory storing a template database including one or more records, each of the one or more records including a template ID and template data, the template data being used to print a predetermined print content based on a predetermined layout, the template ID being associated with the template data;
a printing mechanism;
a communication interface; and
a processor configured to cause the printing apparatus to perform:
an obtaining process of obtaining a print instruction including related information related to print content data which indicates the print content, and the template ID;
a first printing process of causing the printing mechanism to perform printing of a print image in which the print content related to the related information is applied to the layout indicated by the template data associated with the template ID, in a case where the processor obtains the print instruction in the obtaining process;
a first querying process of querying another printing apparatus whether the another printing apparatus possesses the template data associated with the template ID via the communication interface, in a case where the printing by the first printing process is not completed and where the another printing apparatus is connected to the printing apparatus; and
a first transmitting process of transmitting the print instruction to the another printing apparatus via the communication interface, in a case where a result of the first querying process is that the another printing apparatus possesses the template data associated with the template ID.

2. The printing apparatus according to claim 1, wherein in a case where the result of the first querying process is that the another printing apparatus does not possess the template data associated with the template ID, the processor is configured to transmit the print instruction and the template data associated with the template ID to the another printing apparatus via the communication interface, in the first transmitting process.

3. The printing apparatus according to claim 2, wherein in the case where the result of the first querying process is that the another printing apparatus does not possess the template data associated with the template ID, after transmitting the print instruction and the template data, the processor is configured to perform a second transmitting process of transmitting the template database to the another printing apparatus via the communication interface.

4. The printing apparatus according to claim 3, wherein
the first memory stores a print content database including one or more records, each of the one or more records including identification information and the print content data corresponding to the print content, the identification information being associated with and identifying the print content data,
the related information is the identification information,
in the first querying process, the processor is configured to query the another printing apparatus whether the another printing apparatus possesses the print content data associated with the identification information via the communication interface,
in a case where the result of the first querying process is that the another printing apparatus possesses the print content data associated with the identification information, the processor is configured to transmit the print instruction including the identification information to the another printing apparatus via the communication interface, in the first transmitting process, and
in a case where the result of the first querying process is that the another printing apparatus does not possess the print content data associated with the identification information, the processor is configured to transmit the print instruction and the print content data identified from the print content database based on the identification information to the another printing apparatus via the communication interface, in the first transmitting process.

5. The printing apparatus according to claim 4, wherein in the case where the result of the first querying process is that the another printing apparatus does not possess the print content data associated with the identification information, after transmitting the print instruction and the print content data to the another printing apparatus, the processor is configured to perform a third transmitting process of transmitting the print content database to the another printing apparatus via the communication interface.

6. The printing apparatus according to claim 4, wherein in the case where the another printing apparatus does not possess the print content data associated with the identification information,
in the first transmitting process:
the processor is configured to transmit the print instruction and the print content database to the another printing apparatus via the communication interface, in a case where a first condition is satisfied, the first condition being condition that a file size of the print content database is smaller than a predetermined size, and
the processor is configured to transmit the print instruction and the print content data identified from the print content database based on the identification information to the another printing apparatus via the communication interface, in a case where the first condition is not satisfied.

7. The printing apparatus according to claim 4, wherein in the case where the another printing apparatus does not possess the print content data associated with the identification information,
in the first transmitting process:
the processor is configured to transmit the print instruction including the identification information and the print content database to the another printing apparatus via the communication interface, in a case where a second condition is satisfied, the second being a condition that a number of the print content data included in the print content database is greater than a predetermined number; and
the processor is configured to transmit the print instruction and the print content data identified from the print content database based on the identification information to the another printing apparatus via the communication interface, in a case where the second condition is not satisfied.

8. The printing apparatus according to claim 4, wherein
in the case where the printing by the first printing process is not completed, the printing apparatus has a predetermined first-kind error or a predetermined second-kind error which takes a longer time to be resolved than the first-kind error,
in a case where the another printing apparatus does not possess the print content data associated with the identification information,
in the first transmitting process,
the processor is configured to transmit the print instruction including the identification information and the print content database to the another printing apparatus via the communication interface, in a case where a third condition is satisfied, the third condition being a condition that the printing apparatus has the second-kind error, and
the processor is configured to transmit the print instruction and the print content data identified from the print content database based on the identification information to the another printing apparatus via the communication interface, in a case where the third condition is not satisfied.

9. The printing apparatus according to claim 2, wherein
the first memory stores a print content database including one or more records, each of the one or more records including identification information and the print content data corresponding to the print content, the identification information being associated with and identifying the print content data,
the related information is the identification information,
in the first querying process, the processor is configured to query the another printing apparatus whether the another printing apparatus possesses the print content database via the communication interface,
in a case where the result of the first querying process is that the another printing apparatus possesses the print content database, the processor is configured to transmit the print instruction including the identification information to the another printing apparatus via the communication interface, in the first transmitting process, and
in a case where the result of the first querying process is that the another printing apparatus does not possess the print content database, the processor is configured to transmit the print instruction including the identification information and the print content database to the another printing apparatus via the communication interface, in the first transmitting process.

10. The printing apparatus according to claim 1, wherein
the related information is the print content data, and
the processor is configured to obtain the print instruction including the print content data in the obtaining process.

11. The printing apparatus according to claim 3, wherein
after transmitting the print instruction, the processor is configured to perform a first accepting process of accepting a response to a query as to whether the printing apparatus is to be substituted with the another printing apparatus, and
in a case where the processor accepts a response indicating that the printing apparatus is to be substituted with the another printing apparatus in the first accepting process, the processor is configured to transmit the template database to the another printing apparatus via the communication interface, in the second transmitting process.

12. The printing apparatus according to claim 5, wherein
after transmitting the print instruction, the processor is configured to perform afirst accepting process of accepting a response to a query as to whetherthe printing apparatus is to be substituted with the another printing apparatus, and
in a case where the processor accepts a response indicating that the printing apparatus is to be substituted with the another printing apparatus in the first accepting process, the processor is configured to transmit the print content database to the another printing apparatus via the communication interface, in the third transmitting process.

13. The printing apparatus according to claim 11, wherein
in a case where the printing by the first printing process is not completed, the printing apparatus has a predetermined first-kind error or a predetermined second-kind error which takes a longer time to be resolved than the first-kind error,
in a case where the printing apparatus has the first-kind error, the processor is configured not to perform the first accepting process, and
in a case where the printing apparatus has the second-kind error, the processor is configured to perform the first accepting process.

14. The printing apparatus according to claim 1, wherein
the communication interface includes a connection interface through which the another printing apparatus is peer-to-peer connected to the printing apparatus, and
in the first transmitting process, in a case where the connection interface identifies that the another printing apparatus is connected to the printing apparatus, the processor is configured to determine that the another printing apparatus is connected to the printing apparatus.

15. The printing apparatus according to claim 1, further comprising an internal clock,
wherein the processor is configured to perform:
a date-and-time obtaining process of obtaining date-and-time information from the internal clock; and
a second querying process of querying the another printing apparatus as to whether the another printing apparatus has the internal clock, via the communication interface, and
in a case where a result of the second querying process is that the another printing apparatus does not have the internal clock, in the first transmitting process, the processor is configured to transmit the print instruction including the date-and-time information to the another printing apparatus via the communication interface.

16. A printing apparatus configured to substitute for another printing apparatus so as to perform printing in a case where printing by the another printing apparatus is not completed, the printing apparatus comprising:
a second memory storing a template database including one or more records, each of the one or more records including a template ID and template data, the template data being used to print a predetermined print content based on a predetermined layout, the template ID being associated with the template data;
a communication interface;
a printing mechanism; and
a processor,
wherein the processor is configured to cause the printing apparatus to perform:
a second accepting process of accepting a query as to whether the printing apparatus possesses the template data associated with the template ID from the another printing apparatus via the communication interface;
a responding process of responding that the printing apparatus possesses the template data to the another printing apparatus via the communication interface, in a case where the template data associated with the template ID is stored in the second memory;
a second receiving process of receiving a print instruction including the template ID and an identification information used to identify the print content; and
a second printing process of causing the printing mechanism to perform printing of a print image in which the print content based on the print instruction is applied to the layout indicated by the template data, in a case where the processor receives the print instruction in the second receiving process.

17. The printing apparatus according to claim 16, wherein
the processor is configured to respond that the printing apparatus does not possess the template data to the another printing apparatus via the communication interface in the responding process, in a case where the template data associated with the template ID is not stored in the second memory,
in the second receiving process:
the processor is configured to receive the print instruction from the another printing apparatus via the communication interface and not to receive the template data, in a case where the printing apparatus possesses the template data; and
the processor is configured to receive the print instruction and the template data from the another printing apparatus via the communication interface, in a case where the printing apparatus does not possess the template data, and
in the second printing process, in a case where the printing apparatus receives the print instruction and the template data from the another printing apparatus in the second receiving process, the processor is configured to cause the printing mechanism to perform printing of the print image in which the print content based on the print instruction is applied to the layout indicated by the template data.

18. The printing apparatus according to claim 16, wherein in a case where the processor receives, from the another printing apparatus in the second receiving process, the template database and a print content database including one or more records, each of the one or more records including the identification information and print content data indicating the print content, the processor is configured to perform a storing process of storing the template database and the print content database in the second memory.

19. The printing apparatus according to claim 16, wherein in a case where the processor receives the print instruction including date-and-time information, the processor is configured to cause the printing mechanism to perform printing of the print image in which the print content and the date-and-time information based on the print instruction are applied to the layout indicated by the template data, in the second printing process.

20. A non-transitory medium storing a program for a printing apparatus,
the printing apparatus including:
a first memory storing a template database including one or more records, each of the one or more records including a template ID and template data, the template data being used to print a predetermined print content based on a predetermined layout, the template ID being associated with the template data;
a printing mechanism;
a communication interface; and
a processor configured to cause the printing apparatus to perform:
an obtaining process of obtaining a print instruction including related information related to print content data which indicates the print content and the template ID;
a first printing process of causing the printing mechanism to perform printing of a print image in which the print content related to the related information is applied to the layout indicated by the template data associated with the template ID, in a case where the processor obtains the print instruction in the obtaining process;
a first querying process of querying another printing apparatus whether the another printing apparatus possesses the template data associated with the template ID via the communication interface, in a case where the printing by the first printing process is not completed and where the another printing apparatus is connected to the printing apparatus; and
a first transmitting process of transmitting the print instruction to the another printing apparatus via the communication interface, in a case where a result of the first querying process is that the another printing apparatus possesses the template data associated with the template ID.
